(19) United States
(12) Patent Application Publication
(10) Pub. No.: US 2026/0222502 A1
(43) Pub. Date: Jul. 30, 2026

(54) PROCESSING SYSTEM, NON-TRANSITORY RECORDING MEDIUM, AND BINDING MARK DETECTION SYSTEM

(71) Applicants: Akira KUNIEDA, Tokyo (JP); Yuusuke SHIBASAKI, Tokyo (JP); Wataru TAKAHASHI, Tokyo (JP); Tomomichi HOSHINO, Kanagawa (JP); Atsushi SHINODA, Kanagawa (JP); Shota YOSHIDA, Kanagawa (JP); Kotomi KAMEYAMA, Kanagawa (JP); Sho ASANO, Kanagawa (JP); Shuuto TOHKAISHI, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(72) Inventors: Akira KUNIEDA, Tokyo (JP); Yuusuke SHIBASAKI, Tokyo (JP); Wataru TAKAHASHI, Tokyo (JP); Tomomichi HOSHINO, Kanagawa (JP); Atsushi SHINODA, Kanagawa (JP); Shota YOSHIDA, Kanagawa (JP); Kotomi KAMEYAMA, Kanagawa (JP); Sho ASANO, Kanagawa (JP); Shuuto TOHKAISHI, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(73) Assignee: ETRIA CO., LTD., Yokohama (JP)

(21) Appl. No.: 19/425,216

(22) Filed: Dec. 18, 2025

(30) Foreign Application Priority Data
Jan. 27, 2025 (JP) 2025-011597

(51) Int. Cl. H04N 1/00

(52) U.S. Cl. CPC H04N 1/00761; H04N 1/00639; H04N 1/00785

(57) ABSTRACT

A processing system including a post-processing apparatus, a document reader, and circuitry. The post-processing apparatus includes a housing, a processing device, and an ejector. The housing has an opening. The processing device performs a post-processing on a medium on which an image is formed. The ejector ejects the medium subjected to the post-processing by the processing device, from the opening. The document reader reads an image on a document of multiple documents. The circuitry is to detect a binding mark on the document from the image read by the document reader, and move the processing device to a binding position facing the binding mark on the document, when the multiple documents is manually fed through the opening of the post-processing apparatus.

### CROSS-REFERENCE TO RELATED APPLICATION

This patent application is based on and claims priority pursuant to 35 U.S.C. § 119(a) to Japanese Patent Application No. 2025-011597, filed on Jan. 27, 2025, in the Japan Patent Office, the entire disclosure of which is hereby incorporated by reference herein.

### BACKGROUND

### Technical Field

Embodiments of the present disclosure relate to a processing system, a non-transitory recording medium, and a binding mark detection system.

### Related Art

Typically, processing systems in the art are known that include a document reading device that reads an image on a document and a binder that binds a medium on which an image is formed.

When the document reading device is caused to read an already bound document bundle, there is a case where the bound state of the document bundle is released. Then, in order to rebind the document bundle released from the bound state, there is a so-called “manual feed binding” function of binding the document bundle manually fed through an opening.

If the first binding position and the second binding position are different on a front surface of the document bundle, there is a problem that the first binding mark is conspicuous. When the binding positions of the two times are to be matched, there is a problem that the work of the user when manually feeding the document bundle becomes complicated.

### SUMMARY

Embodiments of the present disclosure described herein provide a novel processing system including a post-processing apparatus, a document reader, and circuitry. The post-processing apparatus includes a housing, a processing device, and an ejector. The housing has an opening. The processing device performs a post-processing on a medium on which an image is formed. The ejector ejects the medium subjected to the post-processing by the processing device, from the opening. The document reader reads an image on a document of multiple documents. The circuitry is to detect a binding mark on the document from the image read by the document reader, and move the processing device to a binding position facing the binding mark on the document, when the multiple documents is manually fed through the opening of the post-processing apparatus.

Further, embodiments of the present disclosure described herein provide a non-transitory recording medium stores a program which, when executed by one or more processors of a processing system including a document reader to read an image on a document of multiple documents, and a post-processing apparatus including a housing having an opening, a processing device to perform a post-processing on a medium on which an image is formed, and an ejector to eject the medium subjected to the post-processing by the processing device, from the opening. The processing system causes the one or more processors to perform a method including detecting a binding mark on the document from the image read by the document reader, and moving the processing device to a binding position facing the binding mark when the multiple documents including the document is manually fed through the opening of the post-processing apparatus.

Further, embodiments of the present disclosure described herein provide a binding mark detection system including a processing system and an information processing apparatus. The processing system includes a document reader, a post-processing apparatus, a first communicator, and first circuitry. The document reader reads an image on a document. The post-processing apparatus performs a post-processing on multiple documents including the document. The first circuitry is to control the processing system. The information processing apparatus transmits and receives data with respect to the first communicator of the processing system. The information processing apparatus includes a second communicator and second circuitry. The second communicator transmits and receives data with respect to the processing system. The second circuitry is to control the information processing apparatus. The first circuitry is further to send image data generated by reading the document by the document reader to the information processing apparatus via the first communicator. The second circuitry is further to determine whether to allow the post-processing apparatus to perform a post-processing on the document based on the image data received from the processing system through the second communicator, and transmit determination data that indicates a determination result to the processing system through the second communicator. The first circuitry is further configured to control the post-processing apparatus based on the determination data received from the information processing apparatus through the first communicator.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a view illustrating an internal structure of an image forming system;

FIG. 2 is a view illustrating internal structures of a document conveying device and a document reading device;

FIG. 3A is a side view illustrating an internal configuration of a binding processing apparatus according to the present embodiment;

FIG. 3B is a plan view illustrating a position of a conveyance path;

FIG. 4 is a plan view illustrating a position of an internal tray of the binding processing apparatus according to the present embodiment;

FIGS. 5A and 5B are schematic views illustrating a configuration of a crimp binder;

FIGS. 6A and 6B are views each illustrating a state of the binding processing apparatus until a sheet reaches a conveyance roller pair;

FIGS. 7A and 7B are views each illustrating a state of the binding processing apparatus performing a binding process;

FIG. 8 is a view illustrating the binding processing apparatus in the state illustrated in FIG. 7B as viewed from a sheet thickness direction;

FIGS. 9A and 9B are views each illustrating a state of the binding processing apparatus in a case where a sheet bundle subjected to the binding process is ejected to a second ejection tray;

FIG. 10 is an example of a hardware configuration diagram of the image forming system;

FIG. 11 is another example of a hardware configuration diagram of the image forming system;

FIG. 12 is a flowchart of a manual feed binding control process 1;

FIGS. 13A and 13B are diagrams illustrating examples of a document bundle before binding and after binding, respectively;

FIGS. 13C and 13D are diagrams illustrating examples of a front surface and a back surface of a document whose binding has been released, respectively;

FIGS. 14A, 14B, 14C and 14D are diagrams illustrating variations in orientations of a document set on a placement table;

FIGS. 15A, 15C, 15E and 15G are diagrams illustrating other examples of an image read by front surfaces of a document whose binding has been released;

FIGS. 15B, 15D, 15F and 15H are diagrams illustrating other examples of an image read by back surfaces of a document whose binding has been released;

FIG. 16 is a plan view illustrating a state in which the document bundle of FIG. 13C is manually fed into the binding processing apparatus;

FIG. 17 is a plan view illustrating a state in which the document bundle of FIG. 15G is manually fed into the binding processing apparatus;

FIG. 18 is a screen example of a manual feed notification screen;

FIG. 19 is a flowchart of a manual feed binding control process 2;

FIG. 20 is a flowchart of a manual feed binding control process 3;

FIG. 21 is a flowchart of a manual feed binding control process 4;

FIG. 22 is a flowchart of a manual feed binding control process 5;

FIG. 23 is a flowchart of a manual feed binding control process 6;

FIG. 24 is a flowchart of a manual feed binding control process 7;

FIG. 25 is a flowchart of a manual feed binding control process 8;

FIG. 26 is a flowchart of a manual feed binding control process 9;

FIG. 27 is a flowchart of a manual feed binding control process 10;

FIG. 28 is a flowchart of a manual feed binding control process 11;

FIGS. 29A, 29B, 29C, 29D, 29E and 29F are diagrams illustrating variations of an execution order of multiple jobs;

FIGS. 30A and 30B are screen examples of a manual feed mode transition setting screen and a binding inability notification screen, respectively;

FIGS. 31A and 31B are screen examples of a binding method selection screen and a priority setting screen, respectively;

FIG. 32 is an example of a functional block diagram of a controller;

FIG. 33 is a flowchart illustrating an example of processing of the controller;

FIG. 34 is another example of a functional block diagram of the controller;

FIG. 35 is a flowchart illustrating another example of processing of the controller; and

FIG. 36 is a configuration diagram of a binding mark detection system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

A description is given below of an image forming system 1 according to the present disclosure, with reference to the drawings.

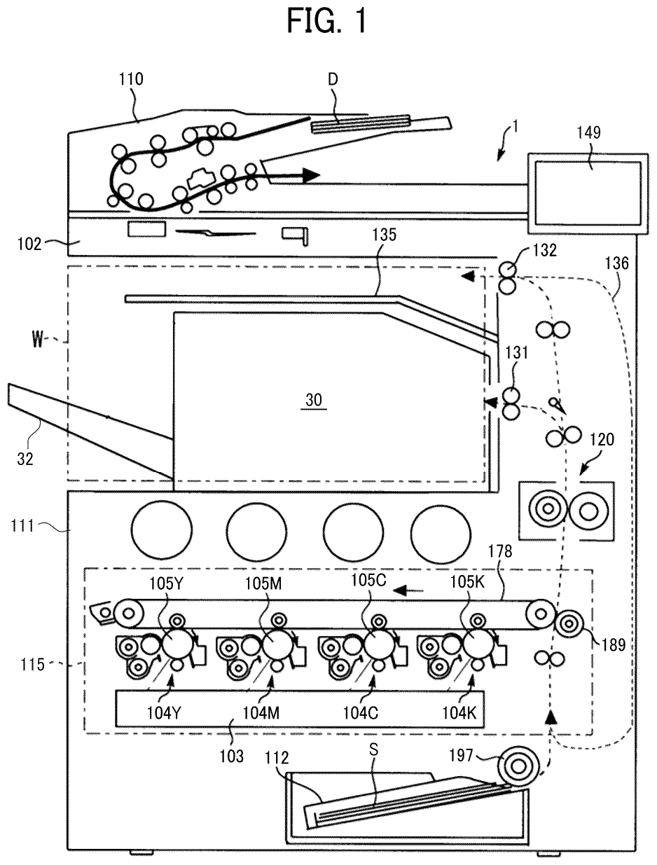

FIG. 1 is a view illustrating an internal structure of the image forming system 1. The image forming system 1 is an apparatus that forms an image on a sheet S which is an example of a sheet-like medium (representatively, a sheet of paper).

As illustrated in FIG. 1, the image forming system 1 mainly includes a housing 111 and an image forming device 115 (image forming apparatus). The image forming system 1 is an example of a processing system. The processing system need not include the image forming device 115.

The housing 111 has a box shape to form an internal space for accommodating components of the image forming system 1. The housing 111 has an in-body space W that is accessible from the outside of the image forming system 1. The in-body space W is located, for example, slightly above the center of the housing 111 in a vertical direction. An outer wall of the housing 111 has been cut out to expose the in-body space W to the outside. In the in-body space W, a processing apparatus (for example, an optional apparatus, a binding processing apparatus 30) that performs various types of processing on the sheet S on which an image is formed by the image forming device 115 is arranged. The in-body space W is a space to which the sheet S ejected from the image forming system 1 can be ejected, and is also a space from which the ejected sheet S can be taken out.

In the in-body space W of the image forming system 1, for example, as illustrated in FIG. 1, the binding processing apparatus 30 (medium processing apparatus) is arranged. In this configuration, multiple sheets S on which an image is formed by the image forming device 115 is subjected to a binding process by the binding processing apparatus 30 and ejected to a second ejection tray 32.

As another example, the optional apparatus and the binding processing apparatus 30 may be arranged in the in-body space W of the image forming system 1. In this configuration, the multiple sheets S on which an image is formed by the image forming device 115 is subjected to a process (for example, a liquid applying process for a binding position, a punching process for a punch hole, or a folding process) by the optional apparatus, then subjected to the binding process by the binding processing apparatus 30, and ejected to the second ejection tray 32.

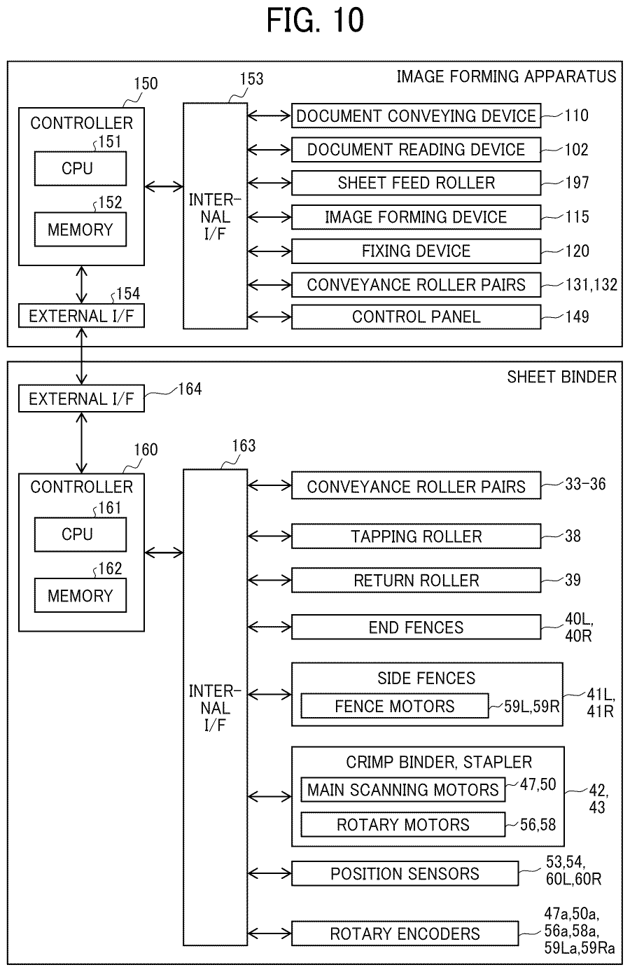

Each of the optional apparatus and the binding processing apparatus 30 is made a unit and has an input and output interface that can be connected to each other to convey the sheet S. In other words, the optional apparatus and the binding processing apparatus 30 are replaceable according to the application of the image forming system 1. More particularly, input interfaces of the optional apparatus and the binding processing apparatus 30 can be connected to an output interface of the image forming device 115. The input interface of the binding processing apparatus 30 can also be connected to an output interface of the optional apparatus. Adjacent units are detachably connected to each other via, for example, a mechanical lock or a magnet. The apparatuses arranged in the in-body space W are each connected to a controller 150 (see FIG. 10) via a harness for transmitting and receiving various signals.

As still another example, the image forming system 1 may be in combination with a post-processing apparatus mounted outside the in-body space W. The post-processing apparatus may be, for example, an apparatus that performs a sorting process of sorting a sheet bundle Sb (medium bundle) ejected from the binding processing apparatus 30. In the in-body space W of the image forming system 1, a relay device that relays the sheet S on which an image is formed and which has been ejected into the in-body space W to the post-processing apparatus may be arranged. The relay device may be integrated with the post-processing apparatus, or may be separately configured and mounted. The post-processing apparatus may be the binding processing apparatus 30.

The image forming system 1 mainly includes a document conveying device 110, a document reading device 102, a sheet tray 112, a sheet feed roller 197, the image forming device 115, a fixing device 120, conveyance roller pairs 131 and 132 (conveying unit), and a first ejection tray 135. In the present specification, an example of the image forming device 115 of an electrophotographic type that forms images using toner will be described, but an inkjet type that forms images using ink may also be used.

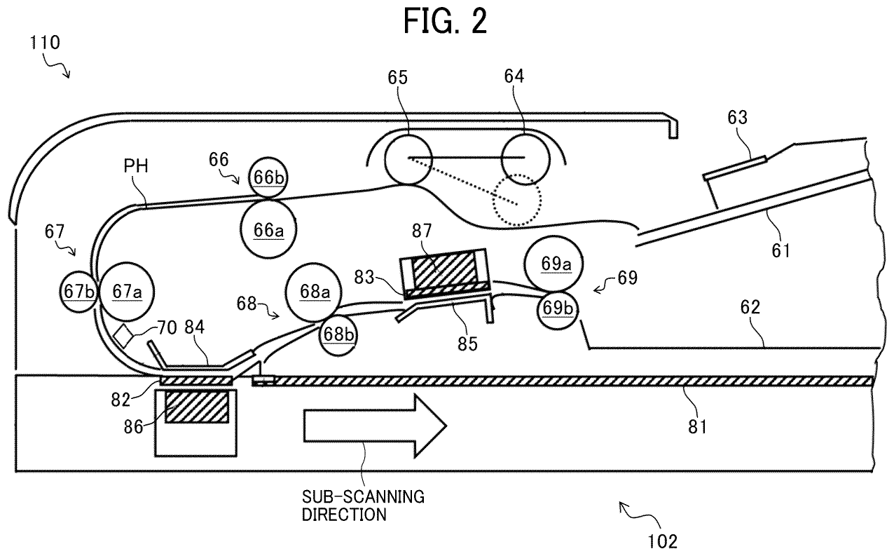

The document conveying device 110 conveys a document D on which an image has already been formed toward the document reading device 102 as a document reader. The document reading device 102 optically reads the image on the document D conveyed by the document conveying device 110 and generates image data. As a reading element of the document reading device 102, for example, a charge coupled device (CCD) sensor, or a complementary metal oxide semiconductor (CMOS) sensor can be used. Details of the document conveying device 110 and the document reading device 102 will be described below with reference to FIG. 2.

The sheet tray 112 accommodates the multiple sheets S in a stack. The sheet feed roller 197 feeds the sheets S accommodated in the sheet tray 112 one by one toward the image forming device 115. The image forming device 115 forms an image indicated by the image data generated by the document reading device 102 (alternatively, received from an external device via a communication network) on the sheet S fed by the sheet feed roller 197. The image forming device 115 includes a writing device 103, image forming units 104Y, 104M, 104C, and 104K, an intermediate transfer belt 178, and a secondary transfer roller 189.

The writing device 103 converts the image indicated by the image data into laser beams of multiple colors (yellow, magenta, cyan, and black), and irradiates photoconductor drums 105Y, 105M, 105C, and 105K of the image forming units 104Y, 104M, 104C, and 104K with the laser beams. As a result, images of corresponding colors are formed on the surfaces of the photoconductor drums 105Y, 105M, 105C, and 105K. Images of respective colors on the photoconductor drums 105Y, 105M, 105C, and 105K are superimposed and transferred onto the intermediate transfer belt 178, forming a color image. The secondary transfer roller 189 transfers the color image on the intermediate transfer belt 178 to the sheet S fed by the sheet feed roller 197, and conveys the sheet S to the fixing device 120.

The fixing device 120 fixes the image transferred to the sheet S by the secondary transfer roller 189 and conveys the sheet S to the conveyance roller pairs 131 and 132. The conveyance roller pair 131 conveys the sheet S which has passed through the fixing device 120 toward the binding processing apparatus 30 arranged in the in-body space W. The conveyance roller pair 132 conveys the sheet S which has passed through the fixing device 120 toward the first ejection tray 135 arranged in the in-body space W. Alternatively, the conveyance roller pair 132 inverts the front and back of the sheet S which has passed through the fixing device 120 through an inverting conveyance path 136 and supplies the sheet S to the image forming device 115 again. The destination of the sheet S which has passed through the fixing device 120 is switched by, for example, a user operation (or an instruction from an external device) through a control panel 149.

### Configurations of Document Conveying Device and Document Reading Device

FIG. 2 is a view illustrating internal structures of the document conveying device 110 and the document reading device 102.

The document conveying device 110 is a device that conveys the document D placed on a placement table 61 to the document ejection tray 62 along the conveyance path PH. The document reading device 102 is a device that reads an image on the document D conveyed by the document conveying device 110 or the document D placed on a contact glass 81 and generates image data.

As illustrated in FIG. 2, the document conveying device 110 includes a placement table 61, a document ejection tray 62, a side guide 63, a feeding roller 64, a feed roller 65, conveyance roller pairs 66, 67, 68, and 69, and a document sensor 70.

The conveyance path PH is a space through which the document D conveyed by the document conveying device 110 passes. The conveyance path PH is a path of the document D from the placement table 61 to the document ejection tray 62 via a position facing a front surface reading module 86 and a back surface reading module 87. The conveyance path PH is a curved conveyance path that is curved inside the document conveying device 110. In the direction along the conveyance path PH, a side toward the placement table 61 is referred to as an “upstream side”, and a side toward the document ejection tray 62 is referred to as a “downstream side”.

The placement table 61 is a portion on which multiple stacked documents D (described below as a “document bundle Db”) can be mounted. The placement table 61 is disposed continuously with an upstream end of the conveyance path PH. The document ejection tray 62 is a portion where the document D conveyed by the document conveying device 110 is ejected. The document ejection tray 62 is disposed continuously with a downstream end of the conveyance path PH.

The side guide 63 abuts on both sides in the width direction of the document bundle Db placed on the placement table 61 to align the position of the document bundle Db in the width direction.

The feeding roller 64 and the feed roller 65 are disposed on the most upstream side (in other words, the vicinity of the connection portion between the conveyance path PH and the placement table 61) of the conveyance path PH. Then, the feeding roller 64 and the feed roller 65 separate one sheet of the document bundle Db placed on the placement table 61 and feed the sheet to the conveyance path PH.

The conveyance roller pairs 66 to 69 are arranged on the conveyance path PH at predetermined intervals. Then, the conveyance roller pairs 66 to 69 convey the document D separated and fed by the feeding roller 64 and the feed roller 65 along the conveyance path PH. The conveyance roller pairs 66 to 69 include driving rollers 66a, 67a, 68a, and 69a and driven rollers 66b, 67b, 68b, and 69b. The basic configuration of the conveyance roller pairs 66 to 69 is common, and thus the conveyance roller pair 66 will be described below.

The driving roller 66a and the driven roller 66b are arranged to face each other across the conveyance path PH (in other words, the document D passing through the conveyance path PH). Then, the driving roller 66a and the driven roller 66b nip the document D passing through the conveyance path PH. The driving roller 66a rotates counterclockwise in FIG. 2 by transmission of driving force of a conveyance motor. The driven roller 66b rotates (is driven) clockwise in FIG. 2 as the driving roller 66a rotates. Then, the driving roller 66a and the driven roller 66b nip and rotate the document D to convey the document D along the conveyance path PH.

The document sensor 70 detects a document D passing through the conveyance path PH and outputs a document signal indicating a detection result to the controller 150 (see FIG. 10) to be described below. More particularly, the document sensor 70 outputs a document signal when detecting the document D, and stops outputting the document signal when not detecting the document D. The document sensor 70 according to the present embodiment is disposed on the downstream side of the conveyance roller pair 67 and on the upstream side of the front surface reading module 86, and detects the document D immediately before facing the front surface reading module 86.

The document reading device 102 includes contact glasses 81, 82, and 83 that transmit light, guide plates 84 and 85 having a color (for example, white) close to the ground color of the document D, a front surface reading module 86, and a back surface reading module 87.

The contact glass 81 is a surface on which the document D is placed by the user. On an upper surface of the contact glass 81, the document D is placed with a reading surface (a surface on which an image is formed) facing downward.

Then, the document D placed on the contact glass 81 is read by the front surface reading module 86 moving in a sub-scanning direction. The document conveying device 110 (including the contact glasses 82 and 83, the guide plates 84 and 85, and the back surface reading module 87) can be integrally moved (rotated) between a covering position (FIG. 2) at which an upper surface of the contact glass 81 is covered and an exposing position at which the upper surface of the contact glass 81 is exposed.

The contact glass 82 and the guide plate 84 are arranged to face each other with the conveyance path PH interposed therebetween. The contact glass 82 is disposed on a side facing the front surface of the document D passing through the conveyance path PH. The contact glass 82 is disposed between the guide plate 84 (in other words, the conveyance path PH) and the front surface reading module 86.

The contact glass 83 and the guide plate 85 are disposed on the downstream side of the contact glass 82 and the guide plate 84 so as to face each other with the conveyance path PH interposed therebetween. The contact glass 82 is disposed on a side facing the back surface of the document D passing through the conveyance path PH. The contact glass 83 is disposed between the guide plate 85 (in other words, the conveyance path PH) and the back surface reading module 87.

The front surface reading module 86 is disposed on the opposite side of the conveyance path PH with the contact glass 82 interposed therebetween. Then, the front surface reading module 86 reads an image on the front surface of the document D passing through the conveyance path PH through the contact glass 82 to generate image data.

The front surface reading module 86 moves in the sub-scanning direction along a lower face of the contact glass 81 by transmission of a driving force of a reading motor. Then, the front surface reading module 86 reads an image on a lower face of the document D placed on the contact glass 81 and generates image data. The back surface reading module 87 is disposed on the opposite side of the conveyance path PH with the contact glass 83 interposed therebetween. Then, the back surface reading module 87 reads an image on the back surface of the document D passing through the conveyance path PH through the contact glass 83 to generate image data.

The front surface reading module 86 and the back surface reading module 87 are integrated with a known light source, lens, and image sensor, for example. Then, the front surface reading module 86 and the back surface reading module 87 irradiate the document D with light from the light source via the contact glasses 81 to 83, and photoelectrically convert the reflected light reflected by the document D by the image sensor, thereby generating image data indicating an image on the document D.

Each of the sheet S and the document D is a sheet-like medium (for example, paper). In the present specification, the sheet S refers to a medium on which an image is formed (alternatively, an image is formed) by the image forming device 115. Meanwhile, the document D refers to a medium on which an image on the front surface or the back surface is read by the document reading device 102.

### Configuration of Binding Processing Apparatus

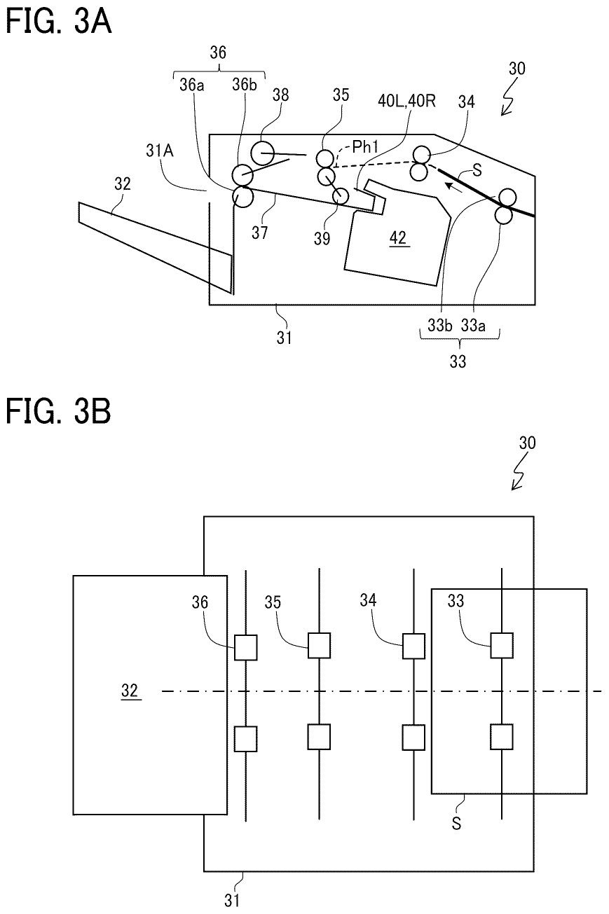

FIG. 3A is a side view illustrating an internal configuration of the binding processing apparatus 30 according to the present embodiment.

FIG. 3B is a plan view illustrating a position of a conveyance path Ph1.

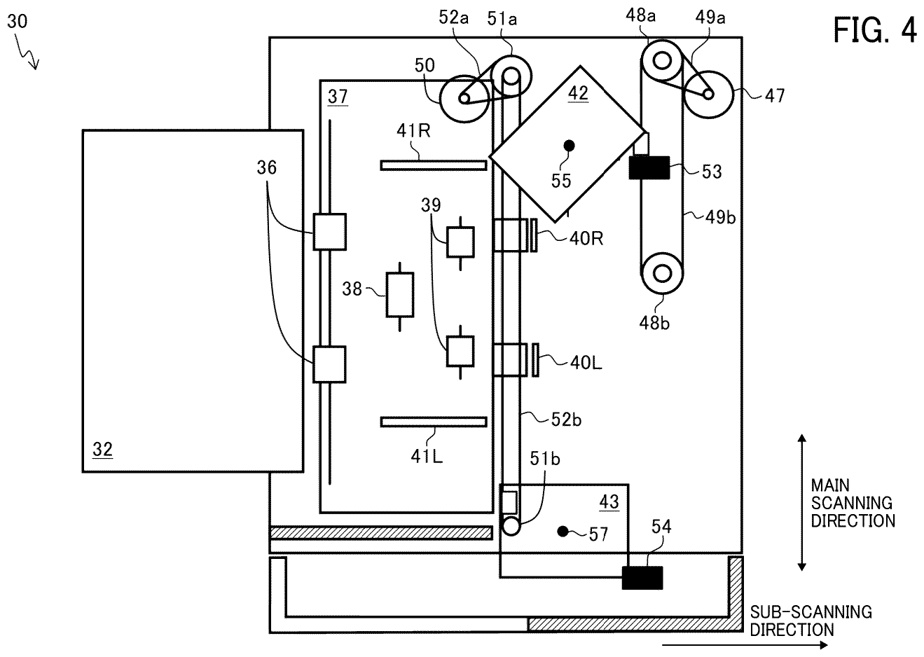

FIG. 4 is a plan view illustrating a position of an internal tray 37 of the binding processing apparatus 30 according to the present embodiment.

The binding processing apparatus 30 (post-processing unit, post-processing apparatus) performs the binding process (post-process) of binding the multiple sheets S (sheet bundle Sb) on which images have been formed by the image forming device 115. As illustrated in FIGS. 3A, 3B and 4, the binding processing apparatus 30 includes a binding case 31 (housing), the second ejection tray 32, multiple conveyance roller pairs 33, 34, 35, and 36 (conveying unit), the internal tray 37 (accumulation unit), a tapping roller 38, a return roller 39, end fences 40L and 40R (conveyance direction alignment unit), side fences 41L and 41R (main scanning direction alignment unit), a crimp binder 42, and a staple binder 43.

In the present specification, a direction toward the end fences 40L and 40R along an upper surface of the internal tray 37 is referred to as a “conveyance direction”. A direction (in other words, a width direction of the sheet S) orthogonal to the conveyance direction and the thickness direction of the sheet S supported by the internal tray 37 is referred to as a “main scanning direction”. The crimp binder 42 and the staple binder 43 are examples of a processing unit that performs processing on the sheet S on which an image is formed by the image forming device 115. The conveyance roller pair 36 is an example of an ejector that ejects the sheet S processed by the processing unit from an opening 31A.

The binding case 31 as a housing has a box shape to form an internal space for accommodating components of the binding processing apparatus 30. The conveyance path Ph1 is formed in the internal space of the binding case 31. The conveyance path Ph1 is a space through which the sheet S passes. The second ejection tray 32 is supported on an outer side surface of the binding case 31. The second ejection tray 32 stacks the sheet S or the sheet bundle Sb conveyed by the conveyance roller pairs 33 to 36.

The conveyance roller pairs 33 to 36 are arranged on the conveyance path Ph1 at predetermined intervals. The conveyance roller pairs 33 to 36 convey the sheet S along the conveyance path Ph1. The conveyance roller pair 33 is configured of a driving roller 33a and a driven roller 33b that are arranged to face each other across the conveyance path Ph1. The driving roller 33a and the driven roller 33b are rotatably supported by the binding case 31. A rotary driving force of a conveyance motor is transmitted to the driving roller 33a to rotate the driving roller 33a forward in a direction of conveying the sheet S (counterclockwise direction in FIGS. 3A and 3B). The driven roller 33b is arranged to face the driving roller 33a across the conveyance path Ph1 and is driven by the rotation of the driving roller 33a. As the conveyance motor is driven with the driving roller 33a and the driven roller 33b nipping the sheet S, the sheet S is conveyed along the conveyance path Ph1.

The basic configuration of the conveyance roller pairs 34 to 36 is common to the conveyance roller pair 33. The conveyance roller pair 36 includes a driving roller 36a and a driven roller 36b that can be brought into contact with and separated from the driving roller 36a. The conveyance roller pair 35 may have a function of shifting the sheet S in the width direction and ejecting the sheet S to the second ejection tray 32.

The internal tray 37 temporarily supports (accumulates) the multiple sheets S conveyed by the conveyance roller pair 36. The tapping roller 38 is supported at an end of a rotation arm above the internal tray 37. As the rotation arm is rotated, the tapping roller 38 supplies the sheet S to the internal tray 37. The return roller 39 rotates while abutting on an upper surface of the sheet S supported by the internal tray 37 to guide the sheet S toward the conveyance roller pair 36.

The end fences 40L and 40R contact the downstream end in the conveyance direction of the sheet S supported by the internal tray 37 to align the position in the conveyance direction of the sheet S. The side fences 41L and 41R contact both ends in the main scanning direction of the sheet S supported by the internal tray 37 to align the position in the main scanning direction of the sheet S. More particularly, the side fences 41L and 41R can be moved independently in the main scanning direction by the transmission of the driving force of the fence motors 59L and 59R (see FIG. 10).

The binding processing apparatus 30 includes position sensors 60L and 60R (see FIG. 10). The position sensors 60L and 60R detect that the side fences 41L and 41R are arranged at home positions in the main scanning direction. The home positions of the side fences 41L and 41R are, for example, positions where the interval in the main scanning direction is the farthest (in other words, it is larger than the maximum width in the main scanning direction of the sheet S that can be stacked on the internal tray 37). For example, the position sensors 60L and 60R output position signals to the controller 160 when the side fences 41L and 41R are arranged at the home positions, and stop outputting position signals when the side fences 41L and 41R are arranged at positions different from the home positions. The specific configurations of the position sensors 60L and 60R are not particularly limited, and for example, a mechanical sensor, an optical sensor, or a magnetic sensor can be adopted. The same applies to other sensors.

The crimp binder 42 and the staple binder 43 (binding units or binders) are arranged at a downstream end in the conveyance direction of the sheet bundle Sb supported by the internal tray 37. The crimp binder 42 and the staple binder 43 are independently movable in the main scanning direction along the sheet bundle Sb supported by the internal tray 37. The crimp binder 42 and the staple binder 43 are independently rotatable around rotation shafts 55 and 57 extending in the thickness direction of the sheet S supported by the internal tray 37. The crimp binder 42 is an example of a first processing unit that presses and deforms the sheet bundle Sb and binds the sheet bundle Sb. The staple binder 43 is an example of a second processing unit that causes a binding staple to penetrate the sheet bundle Sb and bind the sheet bundle Sb. The binding processing apparatus 30 may include one or both of the crimp binder 42 and the staple binder 43.

The crimp binder 42 is movable in the main scanning direction by a main scanning motor 47, a driving pulley 48a, a driven pulley 48b, and endless annular belts 49a and 49b. The main scanning motor 47 generates a driving force for moving the crimp binder 42 in the main scanning direction. The driving pulley 48a and the driven pulley 48b are rotatably supported by the binding case 31 respectively at positions separated from each other in the main scanning direction. The endless annular belt 49a is stretched around an output shaft of the main scanning motor 47 and the driving pulley 48a. The endless annular belt 49b is stretched around the driving pulley 48a and the driven pulley 48b. The crimp binder 42 is attached to the endless annular belt 49b.

The driving force of the main scanning motor 47 is transmitted to the driving pulley 48a through the endless annular belt 49a. The endless annular belt 49b circulates around the driving pulley 48a and the driven pulley 48b as the driving pulley 48a rotates. As a result, the crimp binder 42 attached to the endless annular belt 49b moves in the main scanning direction. The driving pulley 48a, the driven pulley 48b, and the endless annular belts 49a and 49b are an example of a driving force transmission mechanism that transmits the driving force of the main scanning motor 47 to the crimp binder 42. Here, the specific configuration of the driving force transmission mechanism is not limited to the above-described example.

The staple binder 43 is movable in the main scanning direction by a main scanning motor 50, a driving pulley 51a, a driven pulley 51b, and endless annular belts 52a and 52b. The main scanning motor 50 generates a driving force for moving the staple binder 43 in the main scanning direction. The driving pulley 51a and the driven pulley 51b are rotatably supported by the binding case 31 respectively at positions separated from each other in the main scanning direction. The endless annular belt 52a is stretched around an output shaft of the main scanning motor 50 and the driving pulley 51a. The endless annular belt 52b is stretched around the driving pulley 51a and the driven pulley 51b. The staple binder 43 is attached to the endless annular belt 52b.

The driving force of the main scanning motor 50 is transmitted to the driving pulley 51a through the endless annular belt 52a. The endless annular belt 52b circulates around the driving pulley 51a and the driven pulley 51b as the driving pulley 51a rotates. As a result, the staple binder 43 attached to the endless annular belt 52b moves in the main scanning direction. The driving pulley 51a, the driven pulley 51b, and the endless annular belts 52a and 52b are an example of a driving force transmission mechanism that transmits the driving force of the main scanning motor 50 to the staple binder 43. Here, the specific configuration of the driving force transmission mechanism is not limited to the above-described example.

The binding processing apparatus 30 includes position sensors 53 and 54. The position sensors 53 and 54 detect the positions of the crimp binder 42 and the staple binder 43 in the main scanning direction. For example, the position sensors 53 and 54 output a position signal to the controller 160 when the crimp binder 42 and the staple binder 43 are arranged at a predetermined position (home position) in the main scanning direction, and stop outputting the position signal when the crimp binder 42 and the staple binder 43 are arranged at a position different from the home position. The home position of the crimp binder 42 is, for example, a position deviated to one side (back side) in the main scanning direction from the sheet S supported by the internal tray 37. The home position of the staple binder 43 is, for example, a position deviated to the other side (front side) in the main scanning direction from the sheet S supported by the internal tray 37.

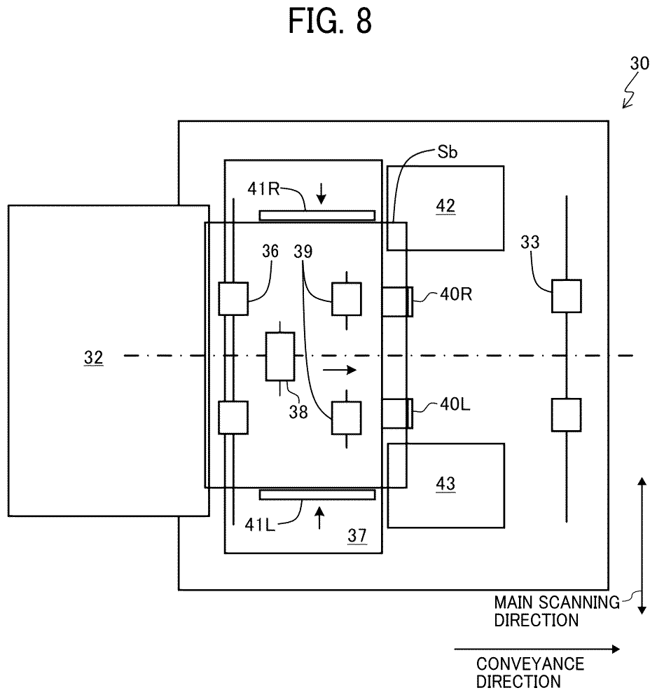

The crimp binder 42 is rotatably supported by the binding case 31 around the rotation shaft 55 extending in the thickness direction of the sheet S supported by the internal tray 37. The crimp binder 42 rotates between a parallel binding posture illustrated in FIG. 8 and an oblique binding posture illustrated in FIG. 4 by transmission of the driving force of a rotary motor 56 (see FIG. 10). Similarly, when the driving force of the rotary motor 58 (see FIG. 10) is transmitted, the staple binder 43 rotates about the rotation shaft 57 extending in the thickness direction of the sheet S supported by the internal tray 37.

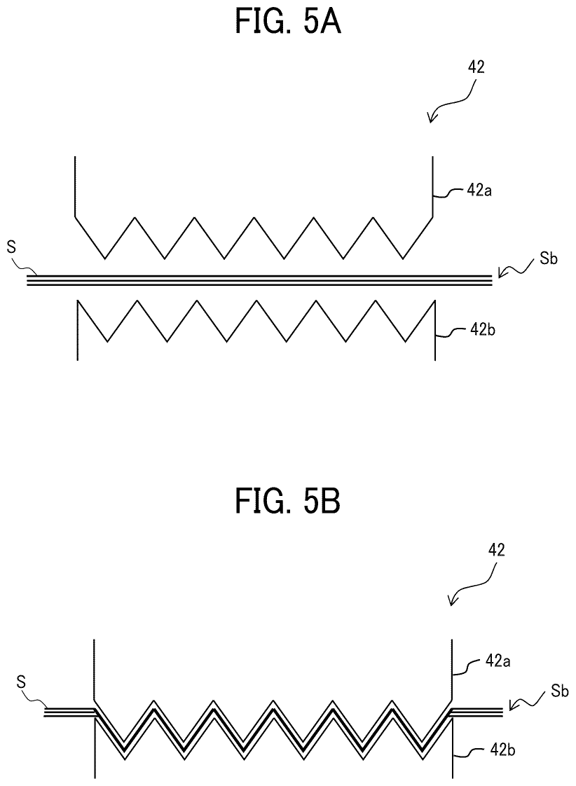

FIGS. 5A and 5B are schematic views illustrating the configuration of the crimp binder 42.

As illustrated in FIGS. 5A and 5B, the crimp binder 42 presses and deforms and nips the sheet bundle Sb by sandwiching the sheet bundle Sb in the thickness direction with an upper crimping teeth 42a (first member) and a lower crimping teeth 42b (second member) having a serrate shape. In short, the crimp binder 42 can bind the sheet bundle Sb without binding staples. The components of the crimp binder 42 (the upper crimping teeth 42a and the lower crimping teeth 42b) are disposed on a crimping frame. Binding by pressing and deforming a binding position of the sheet bundle Sb by the crimp binder 42 will be simply referred to as “crimp binding”.

The crimp binder 42 includes the upper crimping teeth 42a and the lower crimping teeth 42b. The upper crimping teeth 42a and the lower crimping teeth 42b are arranged to face each other in the thickness direction of the sheet bundle Sb to sandwich the sheet bundle Sb placed on the internal tray 37. The upper crimping teeth 42a and the lower crimping teeth 42b have respective serrate faces facing each other. The serrate face of each of the upper crimping teeth 42a and the lower crimping teeth 42b includes concave portions and convex portions alternately formed. The concave portions and the convex portions of the upper crimping teeth 42a are shifted from those of the lower crimping teeth 42b such that the upper crimping teeth 42a are engaged with the lower crimping teeth 42b.

The upper crimping teeth 42a and the lower crimping teeth 42b are brought into contact with and separated from each other by the driving force of a contact-separation motor.

In the process of supplying the multiple sheets S of the sheet bundle Sb to the internal tray 37, the upper crimping teeth 42a and the lower crimping teeth 42b are separated from each other as illustrated in FIG. 5A. Then, when all the sheets S constituting the sheet bundle Sb are placed on the internal tray 37, the upper crimping teeth 42a and the lower crimping teeth 42b are engaged with each other as illustrated in FIG. 5B by the driving force of the contact-separation motor to press and deform the sheet bundle Sb in the thickness direction. Thus, the sheet bundle Sb that has been accumulated on the internal tray 37 is crimped and bound.

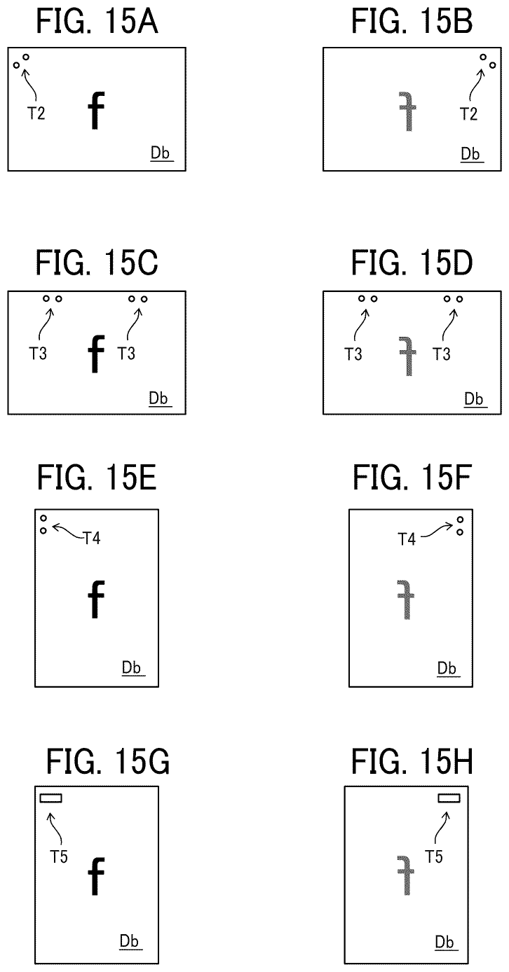

As illustrated in FIGS. 15G and 15H, a rectangular binding mark T5 is formed on the front surface of the sheet bundle Sb crimped by the crimp binder 42. When the crimp binder 42 is in the parallel binding posture, the longitudinal direction of the binding mark B extends in the direction along the main scanning direction (typically parallel). On the other hand, when the crimp binder 42 is in the oblique binding posture, the longitudinal direction of the binding mark B is inclined with respect to the main scanning direction.

Although the configuration of the staple binder 43 is already known and thus detailed description thereof is omitted, the staple binder 43 binds the sheet bundle Sb by causing the binding staple to penetrate the sheet bundle Sb supported on the internal tray 37 by the driving force of the binding motor. The binding by causing the binding staple to penetrate the binding position of the sheet bundle Sb by the staple binder 43 is simply referred to as “staple binding”. The binding staple binding the sheet bundle Sb has a rectangular shape when viewed from the thickness direction of the sheet bundle Sb. The portion of the binding staple on the sheet bundle Sb is also referred to as a “binding mark”.

As illustrated in FIG. 2A, the opening 31A is formed in the binding case 31. More particularly, the opening 31A is provided on a side surface of the binding case 31 supporting the second ejection tray 32 and above the second ejection tray 32. Then, the sheet S or the sheet bundle Sb conveyed by the conveyance roller pair 36 is ejected to the second ejection tray 32 through the opening 31A. The opening 31A is configured such that the sheet bundle Sb can be manually fed into the binding case 31 (more particularly, the internal tray 37 after passing between the pair of separated conveyance roller pair 36) from the outside.

### Basic Operation of Binding Processing Apparatus

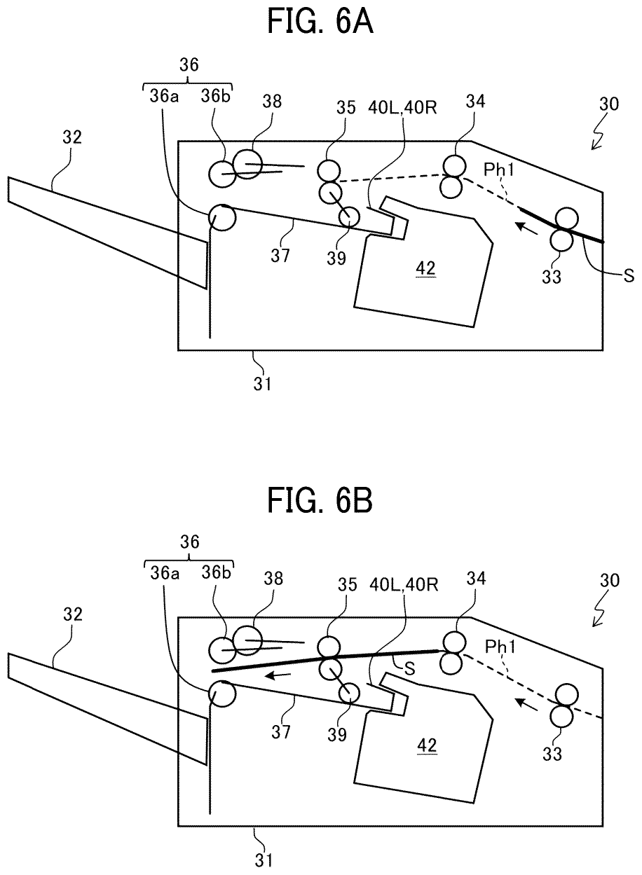

The binding process will be described with reference to FIGS. 6A to 9B.

FIGS. 6A and 6B are views each illustrating a state of the binding processing apparatus 30 until the sheet S reaches the conveyance roller pair 36.

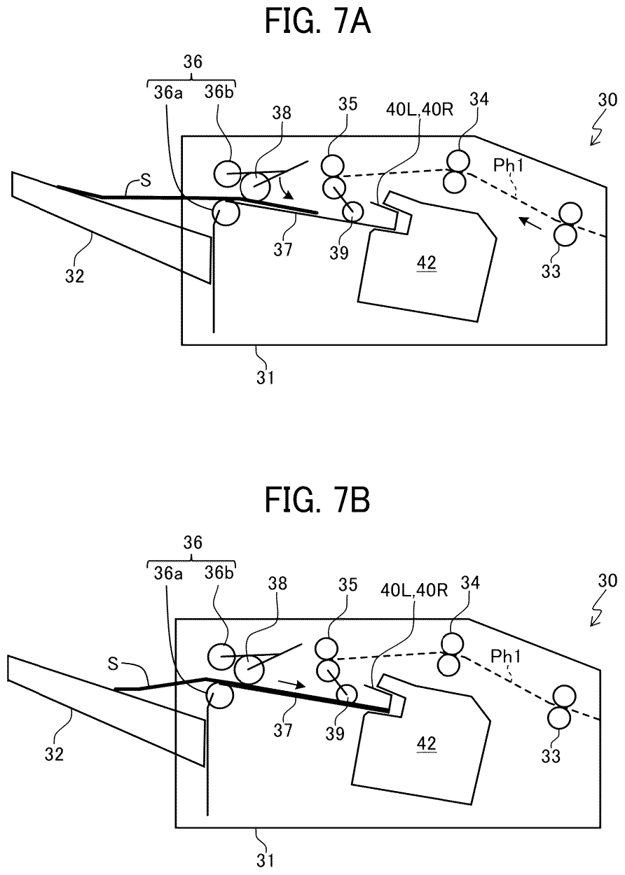

FIGS. 7A and 7B are views each illustrating a state of the binding processing apparatus 30 performing the binding process.

FIG. 8 is a view illustrating the binding processing apparatus 30 in the state illustrated in FIG. 7B as viewed from the thickness direction of the sheet S.

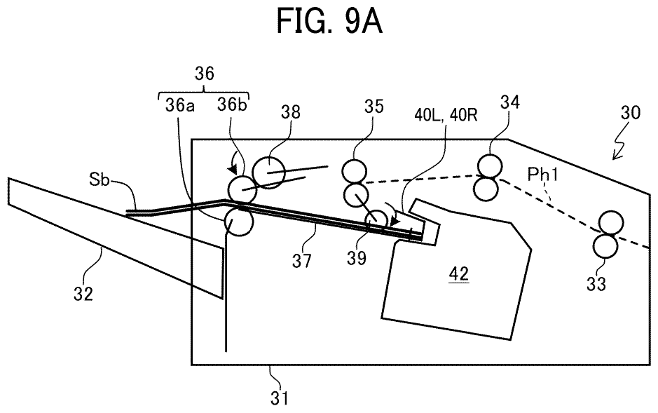

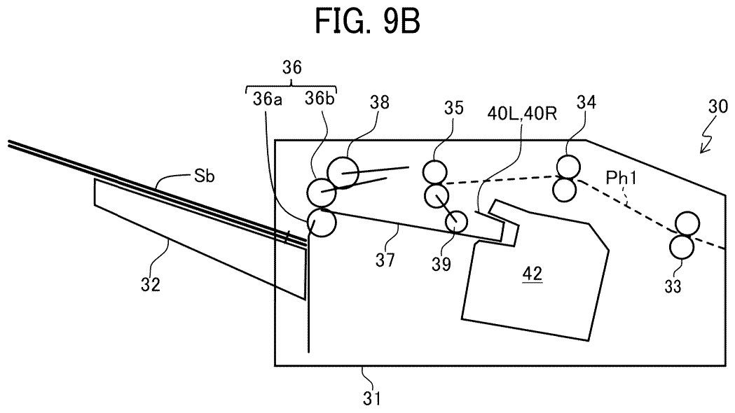

FIGS. 9A and 9B are views each illustrating a state of the binding processing apparatus 30 in a case where the sheet bundle Sb subjected to the binding process is ejected to the second ejection tray 32.

As illustrated in FIGS. 6A and 6B, the binding processing apparatus 30 rotates the conveyance roller pairs 33 to 35 forward to convey the sheet S supplied from the image forming device 115 along the conveyance path Ph1. At this time, in the conveyance roller pair 36, the driving roller 36a and the driven roller 36b are separated from each other.

As illustrated in FIGS. 7A and 7B, the binding processing apparatus 30 brings the tapping roller 38 and the return roller 39 into contact with the sheet S which has passed through the conveyance roller pair 35, and rotates the tapping roller 38 and the return roller 39 to accommodate the sheet S in the internal tray 37. As illustrated in FIG. 8, the downstream end of the sheet S accumulated in the internal tray 37 in the conveyance direction contacts the end fences 40L and 40R, and the position of the sheet S in the conveyance direction is aligned. The binding processing apparatus 30 moves the side fences 41L and 41R in the main scanning direction to align the position of the sheet S accommodated in the internal tray 37 in the main scanning direction (so-called jogging). The binding processing apparatus 30 forms the sheet bundle Sb on the internal tray 37 by repeating the processes illustrated in FIGS. 6A to 8.

As illustrated in FIG. 9A, the binding processing apparatus 30 causes the crimp binder 42 or the staple binder 43 to face the binding position of the sheet bundle Sb in response to a predetermined number of sheets S being stacked on the internal tray 37. Then, the binding processing apparatus 30 performs binding of the sheet bundle Sb supported by the internal tray 37 by driving the crimp binder 42 or the staple binder 43. As illustrated in FIG. 9B, the binding processing apparatus 30 causes the conveyance roller pair 36 to nip and eject the sheet bundle Sb to the second ejection tray 32.

### Hardware Configuration of Image Forming System

FIG. 10 is an example of a hardware configuration diagram of the image forming system 1.

As illustrated in FIG. 10, the image forming system 1 includes, for example, the controller 150 (control unit) that controls the operation of the image forming apparatus of the image forming system 1 and the controller 160 (control unit) that controls the operation of the binding processing apparatus 30. The controllers 150 and 160 cooperatively control the operation of the image forming system 1.

The controllers 150 and 160 include, for example, central processing units (CPUs) 151 and 161 and memories 152 and 162. The memories 152 and 162 include, for example, a read only memory (ROM), a random access memory (RAM), a hard disk drive (HDD), or a combination of ROM, RAM and HDD. The controllers 150 and 160 implement a process to be described below by the CPUs 151 and 161 reading and executing program codes stored in the memories 152 and 162. Here, the specific configurations of the controllers 150 and 160 are not limited thereto, and may be implemented by hardware such as an application specific integrated circuit (ASIC) and a field-programmable gate array (FPGA).

The controller 150 controls operation of the components (for example, the document conveying device 110, the document reading device 102, the sheet feed roller 197, the image forming device 115, the fixing device 120, the conveyance roller pairs 131 and 132, and the control panel 149) of the main body of the image forming system 1 through an internal interface (I/F) 153.

The controller 160 controls operation of the components (for example, the conveyance roller pairs 33 to 36, the tapping roller 38, the return roller 39, the end fences 40L and 40R, the side fences 41L and 41R, the crimp binder 42, the staple binder 43, the position sensors 53, 54, 60L, and 60R, rotary encoders 47a, 50a, 56a, 58a, 59La, and 59Ra) of the binding processing apparatus 30 through an internal interface (I/F) 163. Although merely main motors and sensors of the present disclosure are illustrated in FIG. 10, each component is driven by a motor (drive source), and an operation state (position, posture) is detected by sensors.

The control panel 149 includes an input device that receives inputs from a user and a display (output device) that outputs a notification of information to the user. The input device includes, for example, hard keys and a touch panel superimposed on the display. The control panel 149 acquires information from the operator through the input device and provides information to the operator through the display. A specific example of the output device is not limited to the display and may be a light-emitting diode (LED) lamp or a speaker.

The rotary encoders 47a, 50a, 56a, 58a, 59La, and 59Ra detect drive amounts (rotation amounts) of the main scanning motors 47 and 50, the rotary motors 56 and 58, and the fence motors 59L and 59R. More particularly, the rotary encoders 47a, 50a, 56a, 58a, 59La, and 59Ra output pulse signals to the controller 160 along with the rotation of the main scanning motors 47 and 50, the rotary motors 56 and 58, and the fence motors 59L and 59R. The controller 160 can grasp the drive amounts of the main scanning motors 47 and 50, the rotary motors 56 and 58, and the fence motors 59L and 59R by counting the pulse signals output from the rotary encoders 47a, 50a, 56a, 58a, 59La, and 59Ra.

The controller 160 can grasp the current position of the crimp binder 42 in the main scanning direction by combining the detection results of the position sensor 53 and the rotary encoder 47a. In other words, the position sensor 53 and the rotary encoder 47a may be combined to serve as a position sensor that detects the position of the crimp binder 42 in the main scanning direction. Similarly, the controller 160 can grasp the current position of the staple binder 43 in the main scanning direction by combining the detection results of the position sensor 54 and the rotary encoder 50a. In other words, the position sensor 54 and the rotary encoder 50a may be combined to serve as a position sensor that detects the position of the staple binder 43 in the main scanning direction.

The controller 160 can grasp the current positions of the side fences 41L and 41R in the main scanning direction by combining the detection results of the position sensors 60L and 60R and the rotary encoders 59La and 59Ra. In other words, the position sensors 60L and 60R and the rotary encoders 59La and 59Ra may be combined to serve as position sensors that detect the positions of the side fences 41L and 41R in the main scanning direction.

The controllers 150 and 160 are communicably connected to each other through external I/Fs 154 and 164. The controllers 150 and 160 cooperatively control the operation of each component based on the information transmitted and received through the external I/Fs 154 and 164.

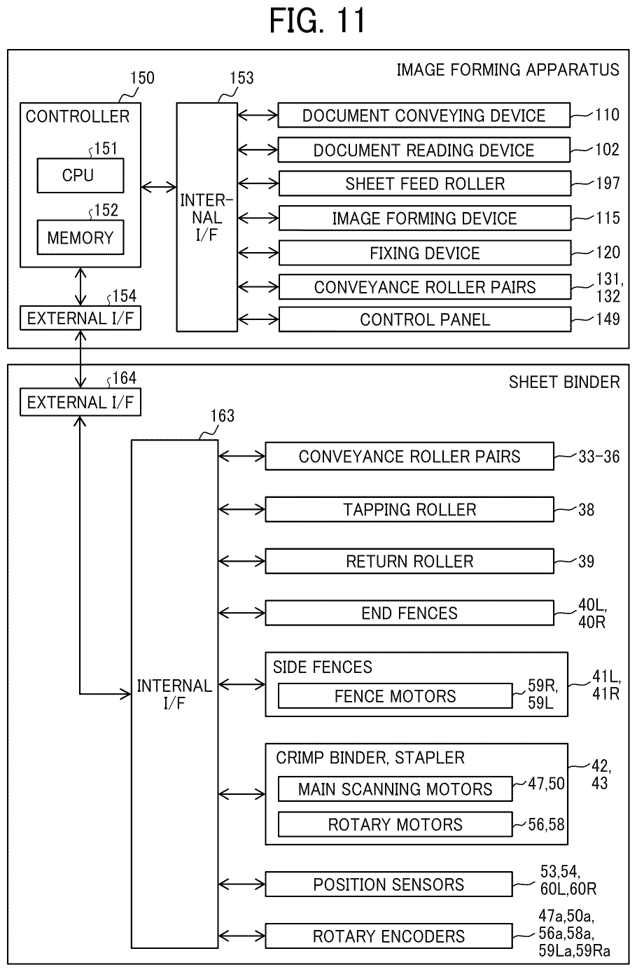

FIG. 11 is another example of a hardware configuration diagram of the image forming system 1.

FIG. 11 is different from FIG. 10 in that the controller 160 of the binding processing apparatus 30 is omitted, and is the same as FIG. 10 in other aspects. The controller 150 illustrated in FIG. 11 controls the operation of the components of the image forming apparatus and the binding processing apparatus of the image forming system 1 through the internal I/F 153, and controls the operation of the components of the binding processing apparatus 30 through the external I/Fs 154 and 164 and the internal I/F 163. In other words, the binding processing apparatus 30 illustrated in FIG. 11 operates under the control of the controller 150 mounted on the main body of the image forming system 1.

The image forming system 1 can execute, for example, a read job and a print job. The read job is a job for causing the document reading device 102 to read an image on the document D to generate image data. The print job is a job of forming an image indicated by image data (in other words, the image data generated by the read job) generated by the document reading device 102 or image data received from an external device on the sheet S. Executing a print job based on image data generated in the read job is referred to as a “read print job”.

As an example of the read job, the user places the document bundle Db on the placement table 61 and inputs a reading instruction through the control panel 149. When the reading instruction is input to the control panel 149, the controller 150 controls the document conveying device 110 to convey the multiple documents D placed on the placement table 61 sheet by sheet. The controller 150 causes the front surface reading module 86 or the back surface reading module 87 to read the document D conveyed by the document conveying device 110, and generates image data.

As another example of the read job, the user places the document bundle Db on the contact glass 81 and inputs a reading instruction through the control panel 149. When the reading instruction is input to the control panel 149, the controller 150 reads an image on the document D placed on the contact glass 81 while moving the front surface reading module 86 in the sub-scanning direction, and generates image data. By repeating this operation, the user can cause the document reading device 102 to read the images on the multiple documents D.

The user inputs a print instruction to the image forming system 1 through an external device. The controller 150 executes a print job when a print instruction is input. In other words, the controller 150 causes the image forming device 115 to form an image indicated by the image data included in the print instruction on the sheet S fed from the sheet tray 112 to the sheet feed roller 197. The controller 150 causes the conveyance roller pairs 131 and 132 to eject the sheet S on which the image is formed by the image forming device 115 toward a ejection destination (the first ejection tray 135 and the second ejection tray 32) included in the print instruction.

The print instruction includes a generation source (an external device, the document reading device 102) of image data to be formed on the sheet S, a size of the sheet S, the number of sheets S on which an image is formed, and an ejection destination (the first ejection tray 135 and the second ejection tray 32) of the sheet S on which an image is formed. The print instruction with the second ejection tray 32 as the ejection destination can include a binding instruction (an instruction to cause the binding processing apparatus 30 to bind the sheet bundle Sb on which the image is formed). The binding instruction includes a binding position (on the sheet bundle Sb, the position in the main scanning direction to be bound by the crimp binder 42 or the staple binder 43), a binding posture (parallel binding posture and oblique binding posture), and a binding method (crimp binding and staple binding).

When a print instruction including a binding instruction is input, the controller 150 of the image forming system 1 notifies the controller 160 of the sheet binder 30 of the binding instruction. When acquiring the binding instruction from the controller 150, the controller 160 causes the crimp binder 42 or the staple binder 43 to bind the sheet bundle Sb on which the image is formed by the image forming device 115 and ejects the sheet bundle Sb to the second ejection tray 32. This process is referred to as a “binding job”.

When a read print instruction is input through the control panel 149, the controller 150 first executes a read job and executes a print job based on image data generated in the read job. In other words, the read print instruction includes a reading instruction and a print instruction. The read print instruction may further include a binding instruction.

When a manual feed binding instruction is input to the control panel 149, the controller 150 of the image forming system 1 notifies the controller 160 of the sheet binder 30 of the manual feed binding instruction. When acquiring the manual feed binding instruction from the controller 150, the controller 160 causes the crimp binder 42 or the staple binder 43 to bind the document bundle Db manually fed into the internal tray 37 through the opening 31A and ejects the document bundle Db to the second ejection tray 32. This process is referred to as a “manual feed binding job”.

### Manual Feed Binding Control Process 1

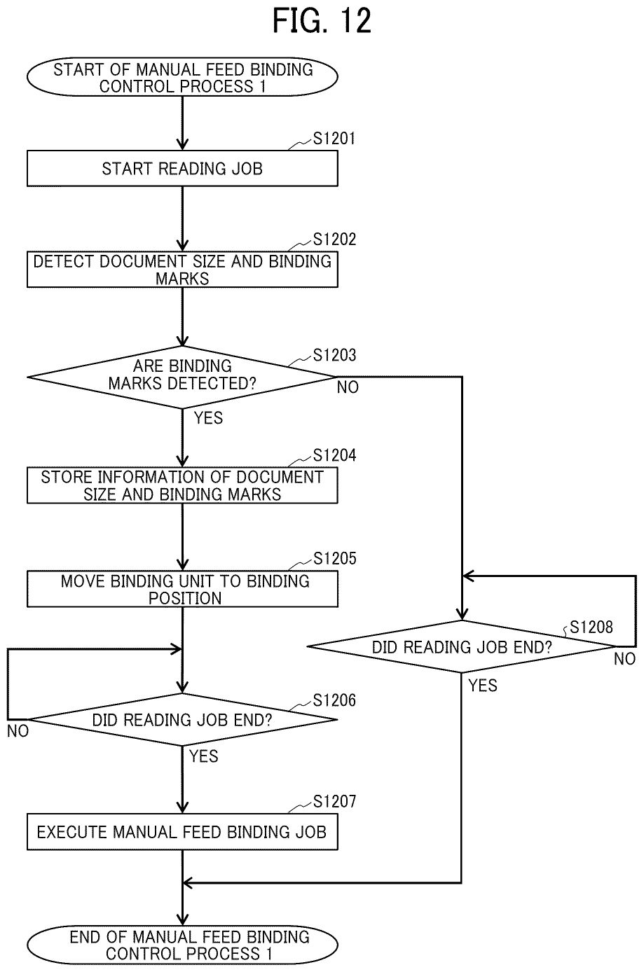

FIG. 12 is a flowchart of a manual feed binding control process 1.

The manual feed binding control process 1 is a process of reading the document bundle Db whose binding has been released in the read job and then re-binding the document bundle Db in the manual feed binding job. It is assumed that the conveyance roller pair 36 is separated from each other and the side fences 41L and 41R, the crimp binder 42, and the staple binder 43 are at home positions at the start time of the manual feed binding control process 1.

For example, the user releases the binding of the document bundle Db that has already been bound, sets the document bundle Db on the placement table 61, and inputs a reading instruction to the control panel 149. “Releasing binding” represents, for example, peeling off a portion crimped and bound by the crimp binder 42 and pulling out a binding staple N penetrated by the staple binder 43 from the document bundle Db. The user may release the binding of the document bundle Db that has already been bound, place the first document D on the contact glass 81, and input a reading instruction to the control panel 149. Then, the user may sequentially execute this process on the multiple documents D constituting the document bundle Db.

When a reading instruction is input to the control panel 149, the controller 150 starts a read job (step S1201). Then, the controller 150 detects the document size (for example, A4 and B4) and the binding mark T (for example, the position of the binding mark T on the document D, the number of binding marks T, the binding method, the posture of the binder (e.g., the crimp binder 42 or the staple binder 43) when binding the binding mark T, and the orientation of the document bundle Db to be inserted through the opening 31A) of the document D first read by the document reading device 102 among the document bundle Db set on the placement table 61 (step S1202).

The controller 150 can detect the document size by a known method. As an example, the controller 150 may detect the document size by a sensor provided in the document conveying device 110. As another example, the controller 150 may analyze the image read by the front surface reading module 86 or the back surface reading module 87 to detect the document size.

The controller 150 detects the binding mark T based on image data generated by causing the front surface reading module 86 or the back surface reading module 87 to read the document D. For the detection of the binding mark T, a known image analysis method can be used. For example, it is sufficient if image preprocessing, edge detection, feature extraction, and pattern matching are performed on image data generated by a read job as follows.

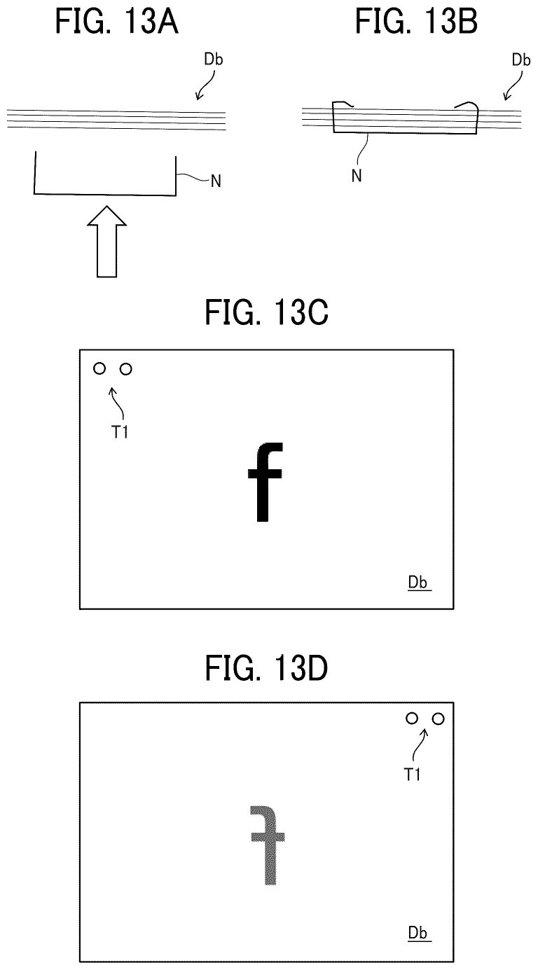

The controller 150 performs, for example, noise removal and contrast adjustment on the image data as image preprocessing. The controller 150 applies an edge detection algorithm as the edge detection to emphasize a contour and a boundary in the image. The controller 150 extracts the feature of the binding mark T from the result of the edge detection as the feature extraction. For example, as illustrated in FIG. 13C, a binding mark T1 after the binding staple N is removed usually appears as a small hole or a broken sheet portion. Therefore, it is sufficient if the controller 150 uses shape analysis or a pattern recognition algorithm to identify these features.

The controller 150 performs pattern matching of the binding mark T with respect to the extracted feature as the pattern matching. It is considered that two holes are arranged at a predetermined interval in the binding mark T1 of the staple binding illustrated in FIG. 13C. Thus, if the two holes are arranged at a predetermined interval, the binding mark T1 can be detected as the binding mark T of the staple binding. The document bundle Db is pressed and deformed to have fine irregularities formed thereon. Thus, the binding mark T5 of the crimp binding illustrated in FIG. 15G can be detected as a binding mark of the crimp binding as long as fine crimping marks are arranged at a certain distance.

FIGS. 13A and 13B are diagrams illustrating examples of the document bundle Db before binding and after binding respectively.

FIGS. 13C and 13D are diagrams illustrating examples of the front surface and the back surface of the documents D whose binding has been released, respectively.

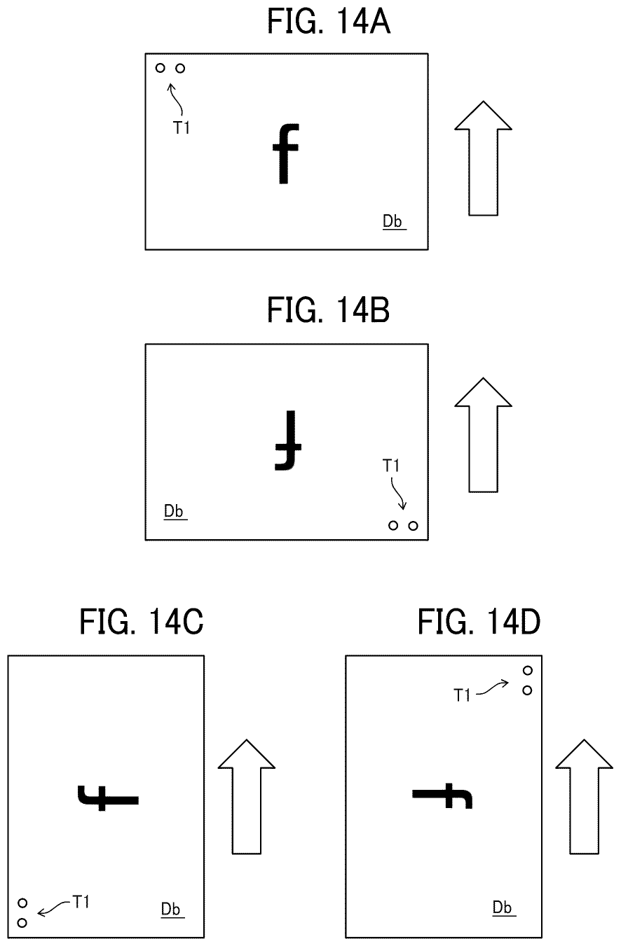

FIGS. 14A to 14D are diagrams illustrating variations in orientations of the document D set on the placement table 61 of the document conveying device 110.

FIGS. 15A, 15C, 15E, and 15G are diagrams illustrating other examples of front surfaces of the document D whose binding has been released.

FIGS. 15B, 15D, 15F, and 15H are diagrams illustrating other examples of back surfaces of the document D whose binding has been released.

For example, as illustrated in FIGS. 13A and 13B, when the document bundle Db is bound by the staple binder 43, the binding staple N penetrates from the lower side (the front side of the first page) of the document bundle Db. Then, the tip of the staple N is folded back to the last page of the document bundle Db (FIG. 13B). Therefore, when the binding of the document bundle Db is released, a binding mark T1 including two through holes remains in the document bundle Db as illustrated in FIGS. 13C and 13D. For example, in a case where the corner of the document bundle Db is stapled by the staple binder 43 in the parallel binding posture, the position of the binding mark T1 is different between a case where the document bundle Db is viewed from the front surface side (FIG. 13C) and a case where the document bundle Db is viewed from the back surface side (FIG. 13D).

As illustrated in FIGS. 14A to 14D, when the document bundle Db placed on the placement table 61 is conveyed in the direction of the arrow, the position of the binding mark T1 changes on the image read by the front surface reading module 86 depending on the direction in which the document bundle Db is set on the placement table 61. Only the side on the downstream side in the direction in which the document bundle Db is inserted into the binding processing apparatus 30 can be bound by the binding processing apparatus 30. Thus, when the image is inverted (in other words, FIGS. 14B to 14D are reversed in the direction of FIG. 14A) such that the binding mark T detected by the pattern matching faces the downstream side in the direction in which the document bundle Db is inserted into the binding processing apparatus 30, the orientation of the document bundle Db to be inserted through the opening 31A of the binding processing apparatus 30, the position of the binding mark T on the document bundle Db, the number of binding marks T, and the binding posture can be specified.

In other words, in the examples of FIGS. 13A to 14D, the controller 150 can detect that the document bundle Db is manually fed into the opening 31A with its long side oriented in the direction in which it is inserted into the binding processing apparatus 30, and that one corner of the document bundle Db on the back side as viewed from the front surface side (a corner on the front side as viewed from the back surface side) is bound with the staple binder 43 in the parallel binding posture.

As illustrated in FIGS. 15A to 15H, the binding processing apparatus 30 can bind the document bundle Db by various methods. FIGS. 15A and 15B illustrate binding marks T2 when the short sides of the document bundle Db are oriented in the conveyance direction and the staple binder 43 in the oblique binding posture is caused to perform staple binding. FIGS. 15C and 15D illustrate binding marks T3 when the short sides of the document bundle Db are oriented in the conveyance direction and the staple binder 43 in the parallel binding posture is caused to perform staple binding at two positions in the main scanning direction. FIGS. 15E and 15F illustrate binding marks T4 when the long sides of the document bundle Db are oriented in the conveyance direction and the staple binder 43 in the parallel binding posture is caused to perform staple binding. FIGS. 15G and 15H illustrate a binding mark T5 when the long sides of the document bundle Db are oriented in the conveyance direction and the crimp binder 42 in the parallel binding posture is caused to perform crimp binding.

Referring back to FIG. 12, when the binding mark T is detected in the read job (YES in step S1203), the controller 150 stores the document size and the binding mark information detected in step S1202 in the memory 152 (step S1204). The controller 150 of the image forming system 1 notifies the controller 160 of the sheet binder 30 of a movement instruction to move the binding unit (the crimp binder 42 or the staple binder 43) to the binding position.

The movement instruction includes, for example, a binding method (crimp binding or staple binding), a position of the binding mark T (described below as a “binding position”), and a binding posture (parallel binding posture and oblique binding posture). The movement instruction when multiple binding marks T is detected includes a binding position to be bound first. Then, the controller 160 moves the binding unit, which is indicated by the binding method and can execute binding, to a position (in other words, a position facing the binding mark T detected in step S1202 when the document bundle Db, which is the target of the read job, is manually fed through the opening 31A) that can face the binding position in accordance with the movement instruction given from the controller 150 (step S1205). The controllers 150 and 160 move one of the crimp binder 42 and the staple binder 43 based on the detected shape of the binding mark T. In other words, the controllers 150 and 160 are configured to cause one of the crimp binder 42 and the staple binder 43 to move to the binding position based on the shape of the binding mark T on the document.

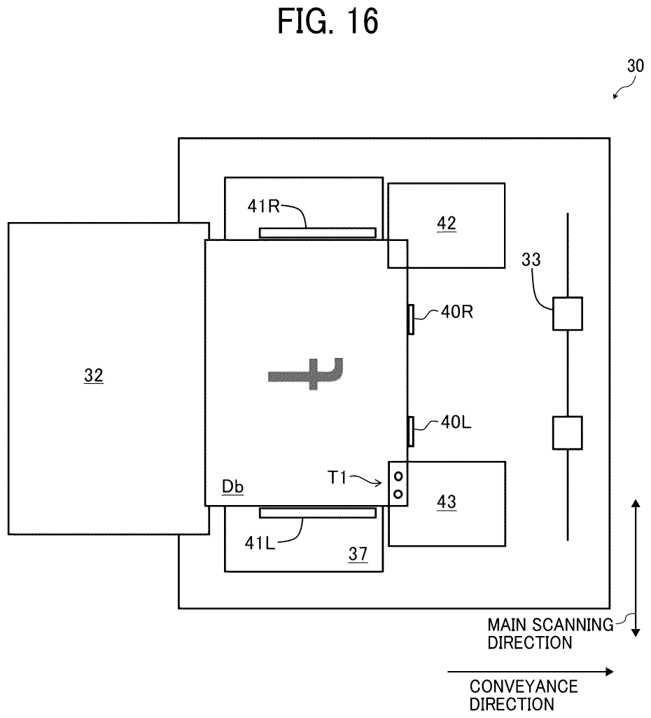

FIG. 16 is a plan view illustrating a state in which the document bundle Db of FIG. 13C is manually fed into the binding processing apparatus 30.

As an example, when the binding mark T1 is detected from the document bundle Db of FIG. 13C, the controller 160 moves the staple binder 43 in the parallel binding posture to the corner on the front side in the main scanning direction to face the detected binding mark T1 as illustrated in FIG. 16. At this time, the document bundle Db is manually fed with the front surface facing downward.

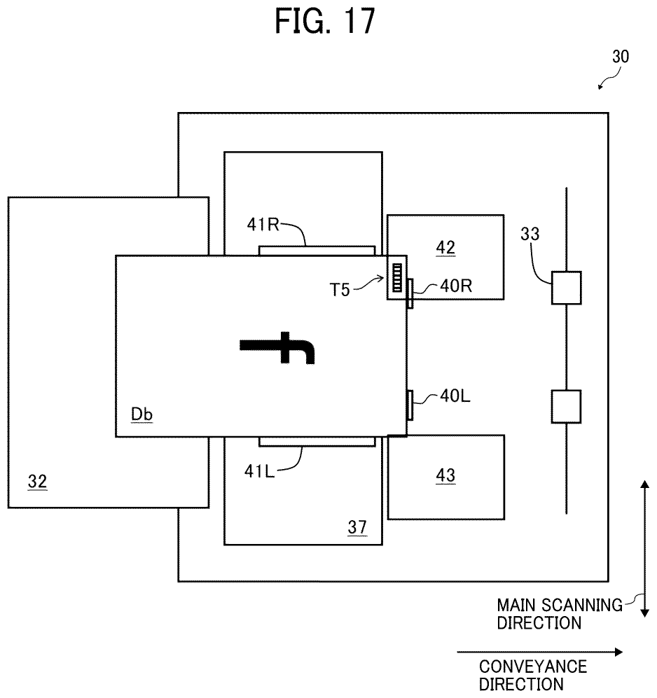

FIG. 17 is a plan view illustrating a state in which the document bundle Db of FIG. 15G is manually fed into the binding processing apparatus 30.

As another example, in a case where the binding mark T5 is detected from the document bundle Db of FIG. 15G, the controller 160 moves the crimp binder 42 to the corner on the back side in the main scanning direction to face the detected binding mark T5 as illustrated in FIG. 17. Since it is not necessary to care about the front and back sides of the binding direction by the crimp binder 42 unlike the staple binder 43, in the example of FIG. 17, the binding direction is manually performed with the front surface of the document bundle Db facing upward.

The controller 160 can omit the movement of the binding unit when the binding unit is already arranged at the position instructed from the controller 150. The controller 150 is not limited to detecting the binding mark T based on the image read from the first document D. In other words, it is sufficient if the controller 150 detects the binding mark T based on an image read from any of the multiple documents D. The controller 150 is not limited to the image read by the front surface reading module 86, and may detect the binding mark T based on the image read by the back surface reading module 87.

Then, the controller 150 causes the document reading device 102 to read all the documents D set on the placement table 61 (step S1206). Then, when all the documents D set on the placement table 61 are read (in other words, the read job has ended) (YES in step S1206), the controller 150 executes a manual feed binding job for the document bundle Db read by the document reading device 102 in the read job (step S1207). On the other hand, when the binding mark T has not been detected (No in step S1203), the controller 150 causes the document reading device 102 to read all the documents D set on the placement table 61 without executing steps S1204 to S1207 (step S1208). In other words, the controller 150 controls the execution timing (more particularly, whether or not to execute step S1205) of step S1205 based on the image read in the read job. In other words, the controller 150 is configured to control timing to move the crimp binder 42 based on the image read by the document reading device 102.

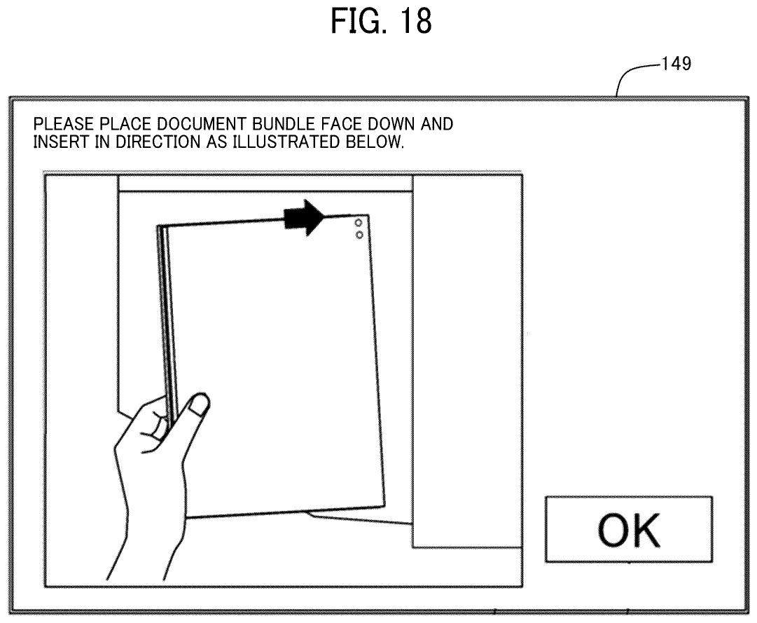

FIG. 18 is a screen example of the manual feed notification screen.

For example, in step S1207, the controller 150 displays the manual feed notification screen illustrated in FIG. 18 on the control panel 149. The manual feed notification screen is a screen that notifies of the orientation of the document bundle Db to be manually fed through the opening 31A. In other words, the controller 150 is configured to output, via the control panel 149, a notification of an orientation of the document bundle Db to be manually fed through the opening 31A.

According to the manual feed notification screen, the user manually feeds the document bundle Db ejected to the document ejection tray 62 into the internal tray 37 through the opening 31A with the first sheet facing downward (in other words, in a state where the binding mark T1 is arranged at the right front corner). As a result, the binding mark T1 of the document bundle Db faces the staple binder 43. Then, the user presses the [OK] icon on the manual feed notification screen. The pressing of the [OK] icon is an example of an instruction to bind the document bundle Db.

When the [OK] icon on the manual feed notification screen is pressed, the controller 150 of the image forming system 1 notifies the controller 160 of the sheet binder 30 of a manual feed binding instruction. The manual feed binding instruction includes, for example, the document size and the binding mark information stored in the memory 152 in step S1204. When acquiring the manual feed binding instruction from the controller 150, the controller 160 causes the binding unit to bind all the binding positions indicated by the manual feed binding instruction. In other words, the controllers 150 and 160 bind the document bundle Db manually fed through the opening 31A to one of the crimp binder 42 and the staple binder 43 based on the detected shape of the binding mark T.

As another example, the controller 150 may cause the control panel 149 to display the manual feed notification screen in which an [OK] icon is omitted, and may notify the controller 160 of the manual feed binding instruction. Then, when a sensor detects that the document bundle Db is manually fed into the internal tray 37, the controller 160 may execute a manual feed binding job according to the manual feed binding instruction.

### Manual Feed Binding Control Process 2

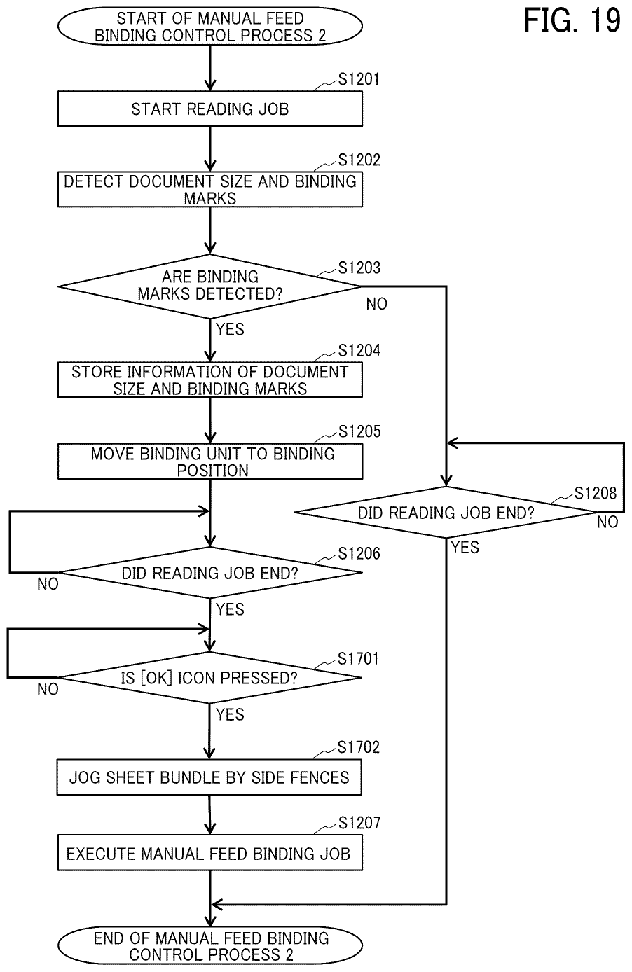

FIG. 19 is a flowchart of a manual feed binding control process 2.

Detailed description of points in common with the manual feed binding control process 1 will be omitted, and differences will be mainly described.

The manual feed binding control process 2 is mainly different from the manual feed binding control process 1 in that the processes of steps S1701 to S1702 are added.

When the [OK] icon on the manual feed notification screen is pressed on the manual feed notification screen to be displayed after the end of the read job (YES in step S1701), the controller 150 of the image forming system 1 notifies the controller 160 of the sheet binder 30 of a manual feed binding instruction. When acquiring the manual feed binding instruction from the controller 150 (in other words, after the document bundle Db is manually fed through the opening 31A), the controller 160 causes the side fences 41L and 41R to align (so-called jogging) the document bundle Db manually fed through the opening 31A in the width direction according to the document size indicated by the manual feed binding instruction (step S1702). After executing the jogging, the controller 160 causes the binding unit to bind the document bundle Db (step S1207).

### Manual Feed Binding Control Process 3

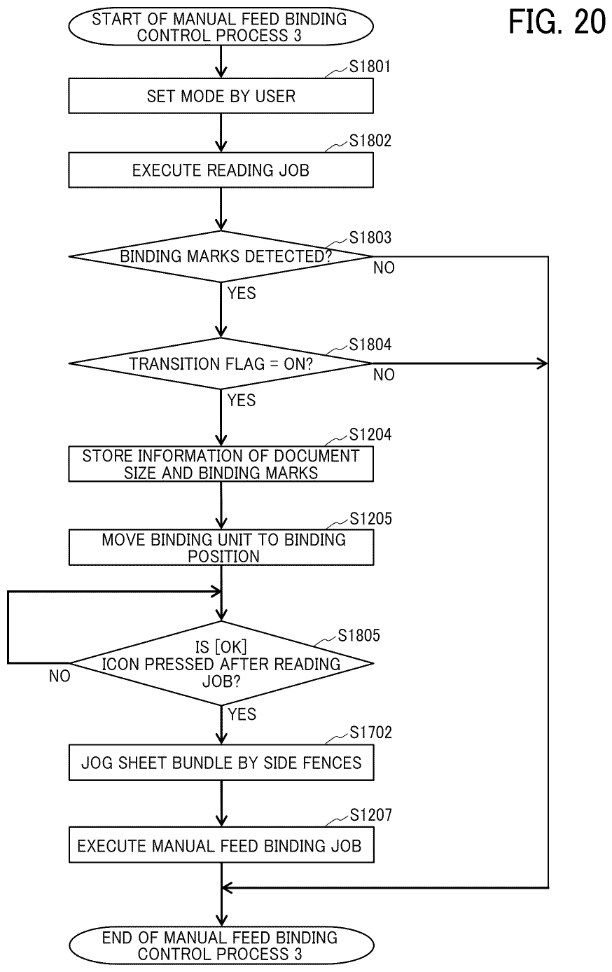

FIG. 20 is a flowchart of a manual feed binding control process 3.

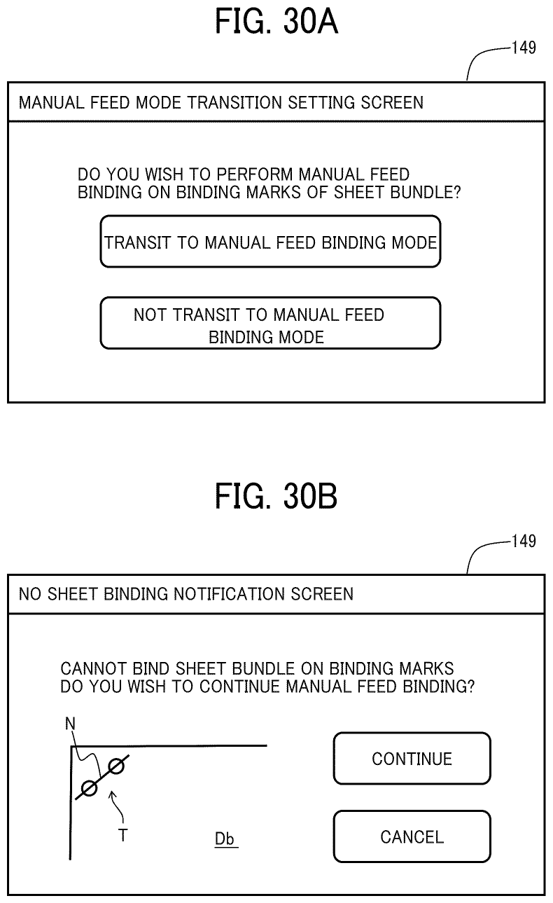

FIG. 30A is a screen example of a manual feed mode transition setting screen.

Detailed description of points in common with the manual feed binding control process 2 will be omitted, and differences will be mainly described.

In the manual feed binding control process 3, processes in steps S1801 to S1805 are mainly different from those in the manual feed binding control process 2. In the flow of FIG. 20, a part of processing blocks common to the manual feed binding control processes 1 and 2 is omitted.

Prior to starting a read job (for example, as a part of the screen for inputting settings of the read job), the controller 150 causes the control panel 149 to display the manual feed mode transition setting screen illustrated in FIG. 30A. The manual feed mode transition setting screen is a screen for allowing the user to set whether or not to manually bind the binding mark T of the document bundle Db as a target of the read job (in other words, the mode transitions to the manual feed binding mode) when the binding mark T is detected in the read job. Then, the controller 150 causes the user to set whether or not to transition to the manual feed binding mode through the control panel 149 (step S1801).

When the [transition to manual feed binding mode] icon is pressed, the controller 150 sets the first value “ON” in the transition flag stored in the memory 152. On the other hand, when the [Not transition to manual feed binding mode] icon is pressed, the controller 150 sets the second value “OFF” in the transition flag stored in the memory 152. The first value “ON” indicates that the mode transitions to the manual feed binding mode, and the second value “OFF” indicates that the mode does not transition to the manual feed binding mode.

The controller 150 executes a read job (step S1802). The processing of step S1802 is common to steps S1201 to S1202. Then, when the binding mark T is detected in the read job (YES in step S1803), the controller 150 determines the setting value of the transition flag (step S1804). Then, when the first value “ON” is set to the transition flag (YES in step S1804), the controller 150 executes the processing of steps S1204 to S1205. When the [OK] icon on the manual feed notification screen is pressed after the end of the read job (YES in step S1805), the controller 150 executes the processing of steps S1702 and S1207. Step S1805 corresponds to steps S1206 to S1701.

On the other hand, when the binding mark T is not detected (NO in step S1803) or when the second value “OFF” is set in the transition flag (NO in step S1804), the controller 150 completes the read job without executing the processing of step S1204 and subsequent steps. In other words, in the manual feed binding control process 3, the processes in and after step S1204 are executed just in a case where the user has set in advance that the document bundle Db to be subjected to the read job is to be manually bound (in other words, the mode transitions to the manual feed binding mode).

### Manual Feed Binding Control Process 4

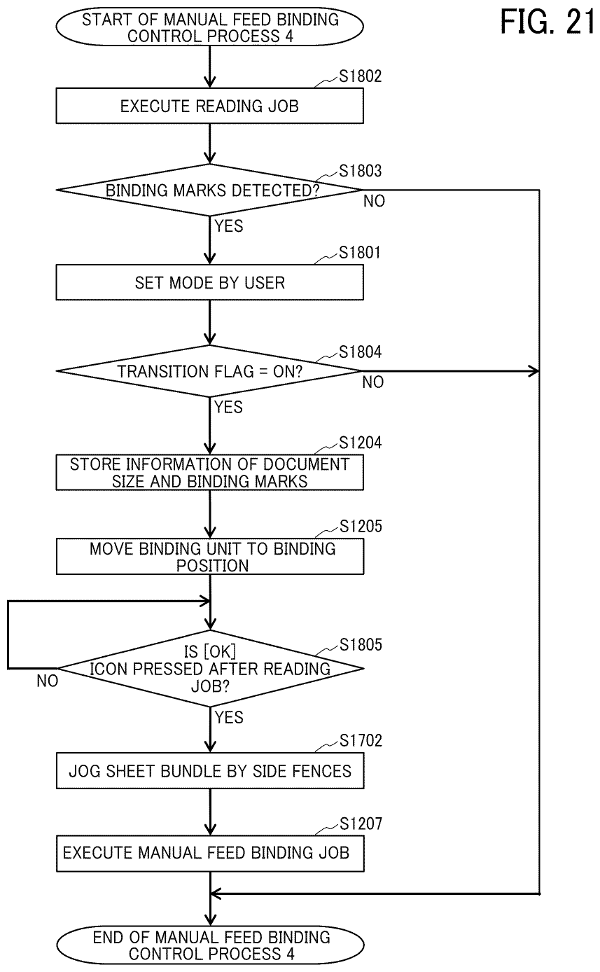

FIG. 21 is a flowchart of a manual feed binding control process 4.

Detailed description of points in common with the manual feed binding control process 3 will be omitted, and differences will be mainly described.

In the manual feed binding control process 4, an execution timing of step S1801 is mainly different from the execution timing of the manual feed binding control process 3.

When the binding mark T is detected in the read job (YES in step S1803), the controller 150 causes the control panel 149 to display the manual feed mode transition setting screen (step S1801). Then, when the [transition to manual feed binding mode] icon is pressed (YES in step S1804), the controller 150 executes the processing in and after step S1204. On the other hand, when the [Not transition to manual feed binding mode] icon is pressed (NO in step S1804), the controller 150 completes the read job without executing the processing in and after step S1204.

### Manual Feed Binding Control Process 5

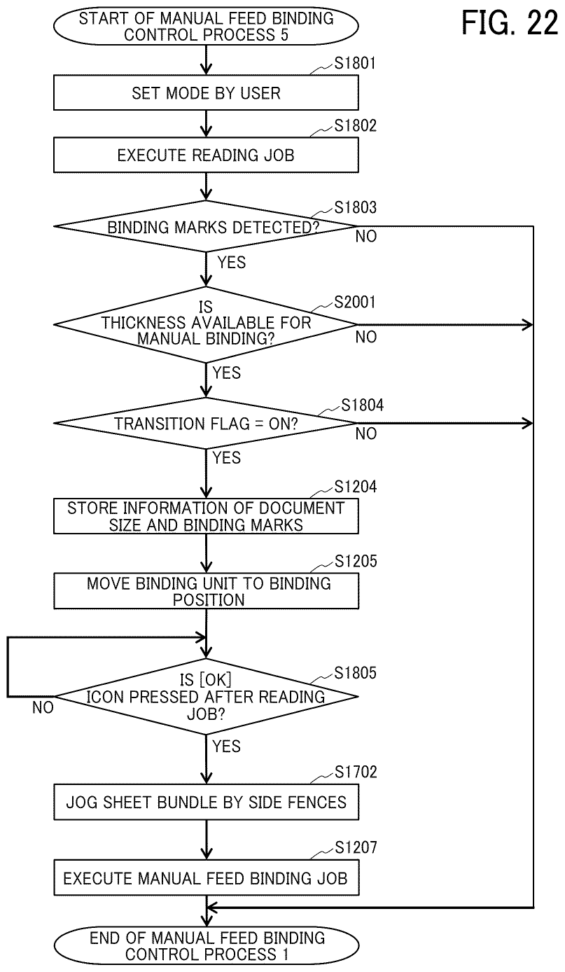

FIG. 22 is a flowchart of a manual feed binding control process 5.

Detailed description of points in common with the manual feed binding control process 3 will be omitted, and differences will be mainly described.

The manual feed binding control process 5 is mainly different from the manual feed binding control process 3 in that step S2001 is added.

When the binding mark T is detected in the read job (YES in step S1803: Yes), the controller 150 compares the thickness (in other words, the total thickness of the multiple documents D constituting the document bundle Db) of the document bundle Db with the maximum thickness that can be bound at the binding unit (step S2001). The total thickness is specified by, for example, a product of a preset thickness of the document D and the number of documents D read in the read job. For example, the controller 150 may cause the user to input the type (for example, plain paper, high quality paper, and glossy paper) of the document D through the control panel 149 at the start of the read job, count the number of documents D during the execution of the read job, and multiply the thickness corresponding to the type of the document D by the number of documents D.

Then, when the total thickness is equal to or less than the maximum thickness (YES in step S2001) and the first value “ON” is set to the transition flag (YES in step S1804), the controller 150 executes the processing in and after step S1204. On the other hand, when the total thickness is larger than the maximum thickness (NO in step S2001) or when the second value “ON” is set in the transition flag (NO in step S1804), the controller 150 completes the read job without executing the processing of step S1204 and subsequent steps. The execution order of the processing in steps S2001 and S1804 may be reversed. When the total thickness is larger than the maximum thickness (NO in step S2001), the controller 150 may notify through the control panel 149 that the document bundle Db read in the read job is not bound by the binding processing apparatus 30.

### Manual Feed Binding Control Process 6

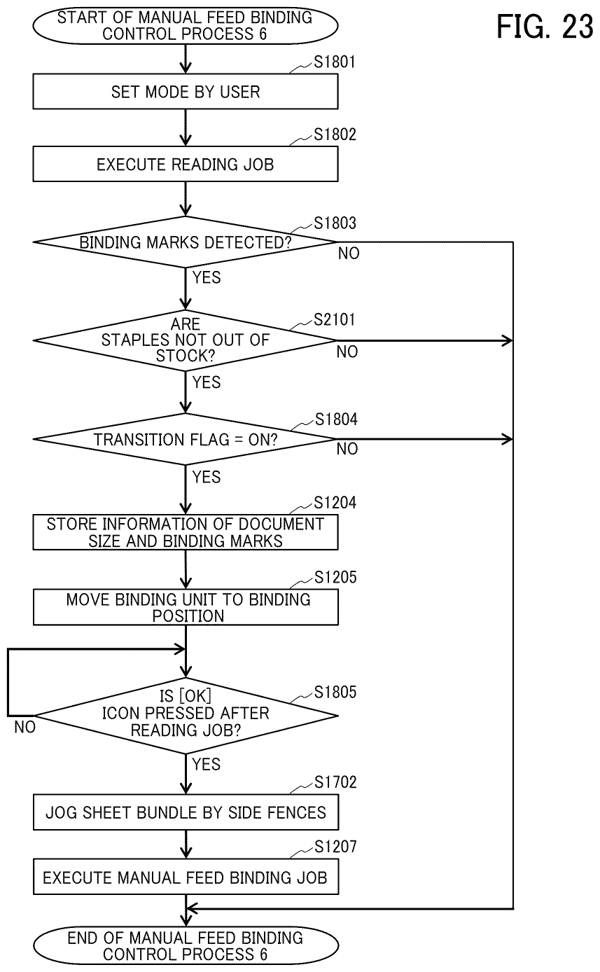

FIG. 23 is a flowchart of a manual feed binding control process 6.

Detailed description of points in common with the manual feed binding control process 3 will be omitted, and differences will be mainly described.

The manual feed binding control process 6 is mainly different from the manual feed binding control process 3 in that step S2101 is added.

When the binding mark T of the staple binding is detected in the read job (YES in step S1803), the controller 150 determines whether or not the binding staple M is loaded in the cartridge of the staple binder 43 (in other words, whether the staple binder 43 can perform staple binding) (step S2101). For example, the controller 150 may determine the presence or absence of the binding staple M in the cartridge by a sensor that detects the binding staple M mounted on the staple binder 43.

Then, in a case where the binding staple M is loaded in the cartridge (YES in step S2101) and the first value “ON” is set in the transition flag (YES in step S1804), the controller 150 executes the processing in and after step S1204. On the other hand, in a case where the binding staple M is not loaded in the cartridge (NO in step S2101) or the second value “ON” is set in the transition flag (NO in step S1804), the controller 150 completes the read job without executing the processing of step S1204 and subsequent steps. The execution order of the processing in steps S2101 and S1804 may be reversed.

### Manual Feed Binding Control Process 7

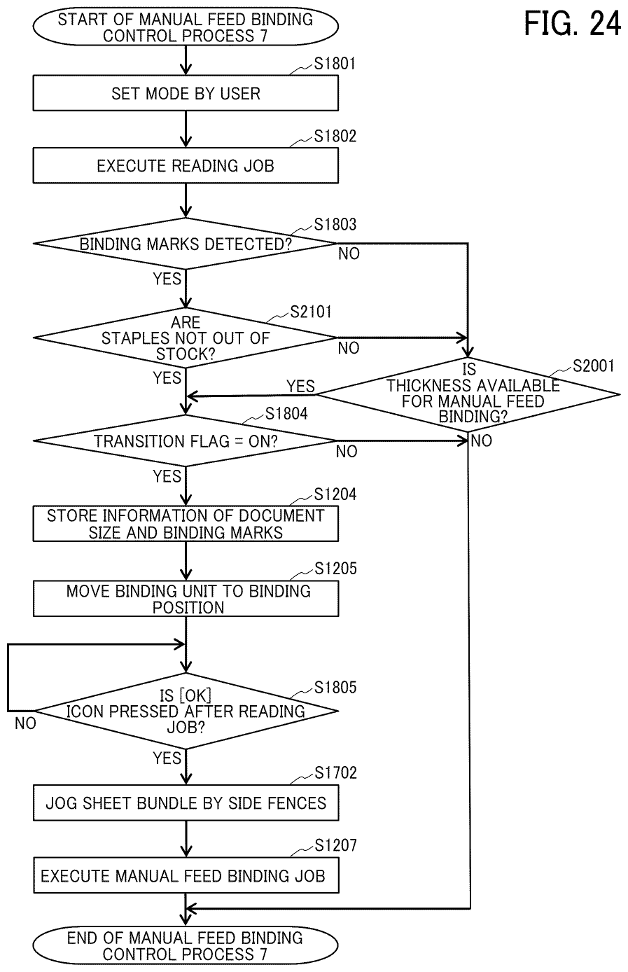

FIG. 24 is a flowchart of a manual feed binding control process 7.

Detailed description of points in common with the manual feed binding control process 3 will be omitted, and differences will be mainly described.

The manual feed binding control process 7 is mainly different from the manual feed binding control process 3 in that both steps S2001 and S2101 are added.

In a case where the binding staple M is loaded in the cartridge (YES in step S2101), the total thickness is equal to or less than the maximum thickness (YES in step S2001), and the first value “ON” is set to the transition flag (YES in step S1804), the controller 150 executes the processing in and after step S1204. On the other hand, in a case where the binding staple M is not loaded in the cartridge (NO in step S2101), the total thickness is larger than the maximum thickness (NO in step S2001), or the second value “ON” is set in the transition flag (NO in step S1804), the controller 150 completes the read job without executing the processing in and after step S1204. The execution order of the processing in steps S2101, S2001, and S1804 may be reversed.

### Manual Feed Binding Control Process 8

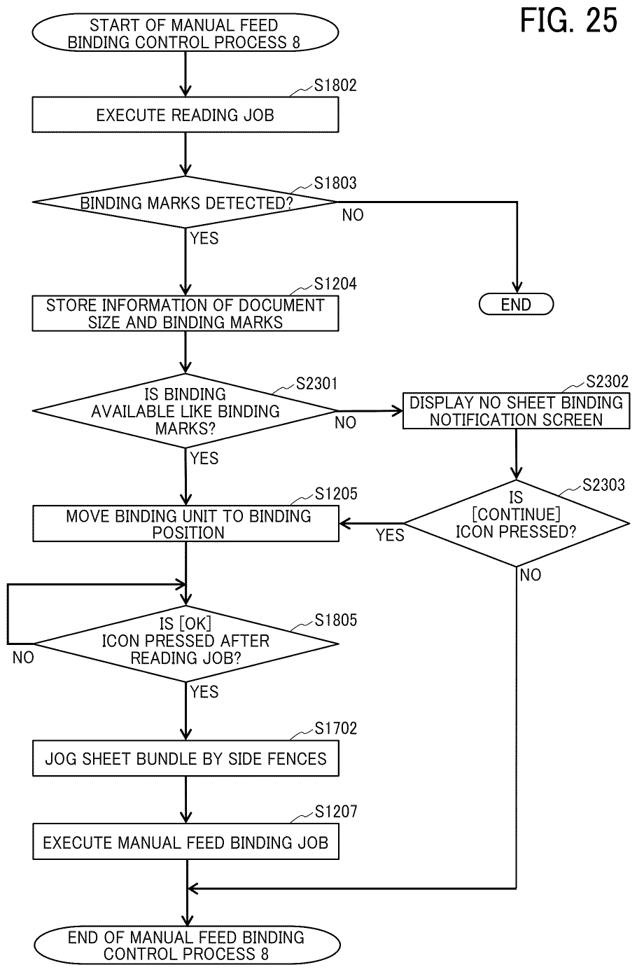

FIG. 25 is a flowchart of a manual feed binding control process 8.

FIG. 30B is a screen example of a binding inability notification screen.

Detailed description of points in common with the manual feed binding control process 3 will be omitted, and differences will be mainly described.

The manual feed binding control process 8 is mainly different from the manual feed binding control process 3 in that steps S2301 to S2303 are added.

When the binding mark T is detected in the read job (YES in step S1803), the controller 150 stores the document size and the binding mark information in the memory 152 (step S1204). Then, the controller 150 determines whether or not the document bundle Db can be bound similarly to the binding mark T detected in the read job (step S2301).

To be “bound similarly to the binding mark T” refers to, for example, overlapping the binding mark T (in other words, in conformity with the binding mark) and binding the document bundle Db again. For example, as illustrated in FIG. 30B, in a case where the binding staple N is removed from the document bundle Db stapled by a device (for example, a stapler) other than the staple binder 43, the read job is executed, and then the staple binding is performed again by the staple binder 43, the size of the binding staple N may be different. In this case, for example, it is sufficient if the controller 150 compares the distance between the two through holes of the detected binding mark T with the size of the binding staple N mounted on the staple binder 43.

Then, when determining that the binding can be performed similarly to the binding mark T (in other words, the size of the binding staple N in conformity with the interval between the through holes of the binding mark T) (YES in step S2301), the controller 150 executes the processing in and after step S1205. On the other hand, when determining that the binding cannot be performed similarly to the binding mark T (in other words, the size of the binding staple N does not match the interval between the through holes of the binding mark T) (NO in step S2301), the controller 150 causes the control panel 149 to display the binding inability notification screen illustrated in FIG. 30B (step S2302).

The binding inability notification screen is a screen for notifying the user that binding cannot be performed similarly to the binding mark T. The binding inability notification screen includes, for example, an image diagram in which the binding staple N mounted on the staple binder 43 is superimposed on the binding mark T of the image read in the read job, a [continue] icon for giving an instruction to continue the manual feed binding, and a [stop] icon for giving an instruction to stop the manual feed binding.

When the [continue] icon is pressed (YES in step S2303), the controller 150 executes the processing in and after step S1205. The pressing of the [continue] icon is an example of an instruction to bind the document bundle Db. In step S1207, it is sufficient if the controller 150 of the image forming system 1 notifies the controller 160 of the sheet binder 30 of a manual feed binding instruction so as to bind the binding position having the largest overlap with the detected binding mark T. On the other hand, when the [cancel] icon is pressed (NO in step S2303), the controller 150 completes the read job without executing the processing in and after step S1205.

### Manual Feed Binding Control Process 9

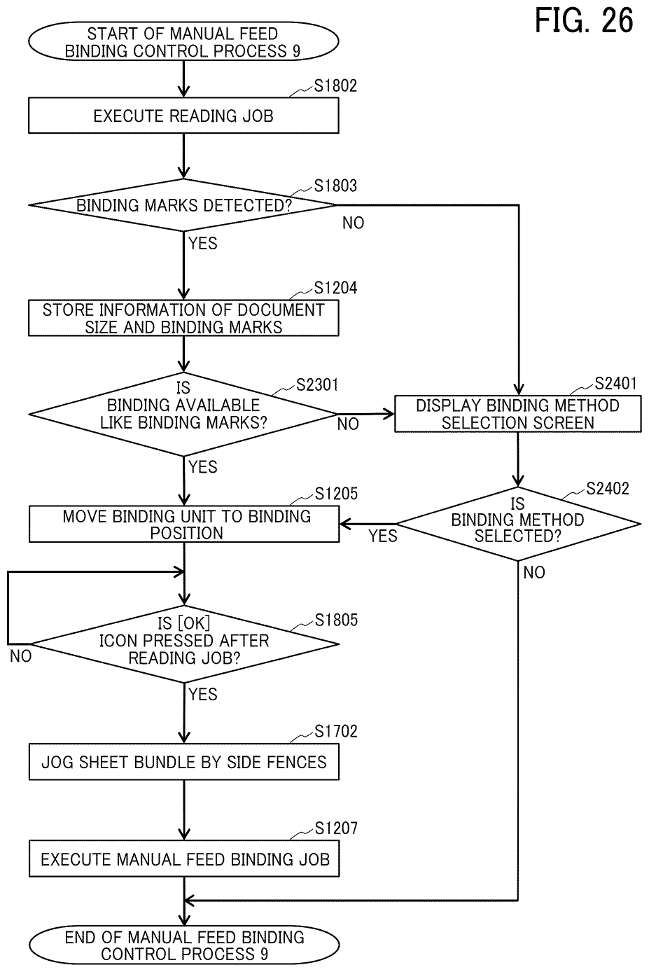

FIG. 26 is a flowchart of a manual feed binding control process 9.

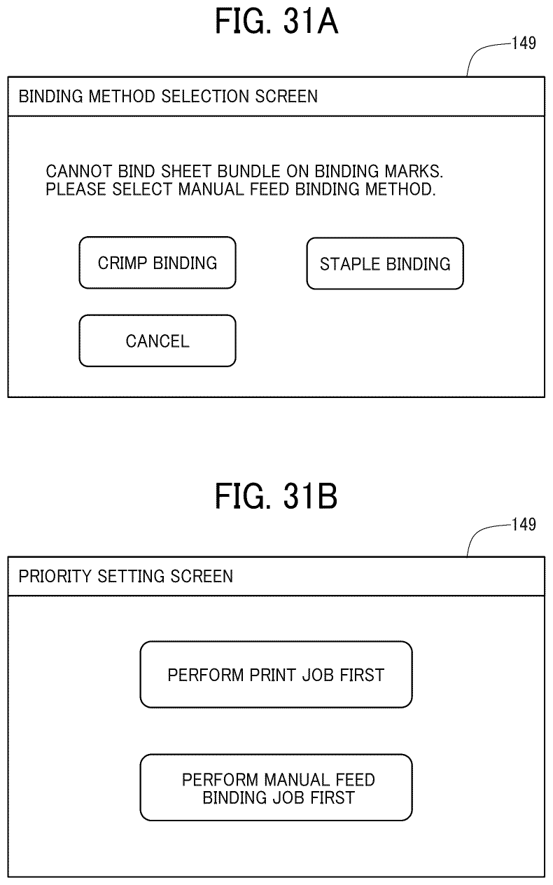

FIG. 31A is a screen example of a binding method selection screen.

Detailed description of points in common with the manual feed binding control process 3 will be omitted, and differences will be mainly described.

The manual feed binding control process 9 is mainly different from the manual feed binding control process 3 in that steps S2301 and S2401 to S2402 are added.

When determining that the binding cannot be performed similarly to the binding mark T (NO in step S2301), the controller 150 displays the binding method selection screen illustrated in FIG. 31A on the control panel 149 (step S2401). The binding method selection screen is a screen for allowing the user to select a method of binding the document bundle Db that has been manually fed and bound. The binding method selection screen includes, for example, a [crimp binding] icon for instructing crimp binding, a [staple binding] icon for instructing staple binding, and a [cancel] icon for instructing cancellation of manual feed binding.

Then, when the [crimp binding] icon or the [staple binding] icon is pressed (YES in step S2402), the controller 150 executes the processing in and after step S1205. In step S1207, the controller 150 of the image forming system 1 notifies the controller 160 of the sheet binder 30 of a manual feed binding instruction including the binding method selected through the binding method selection screen. On the other hand, when the [cancel] icon is pressed (NO in step S2402), the controller 150 completes the read job without executing the processing in and after step S1205.

### Manual Feed Binding Control Process 10

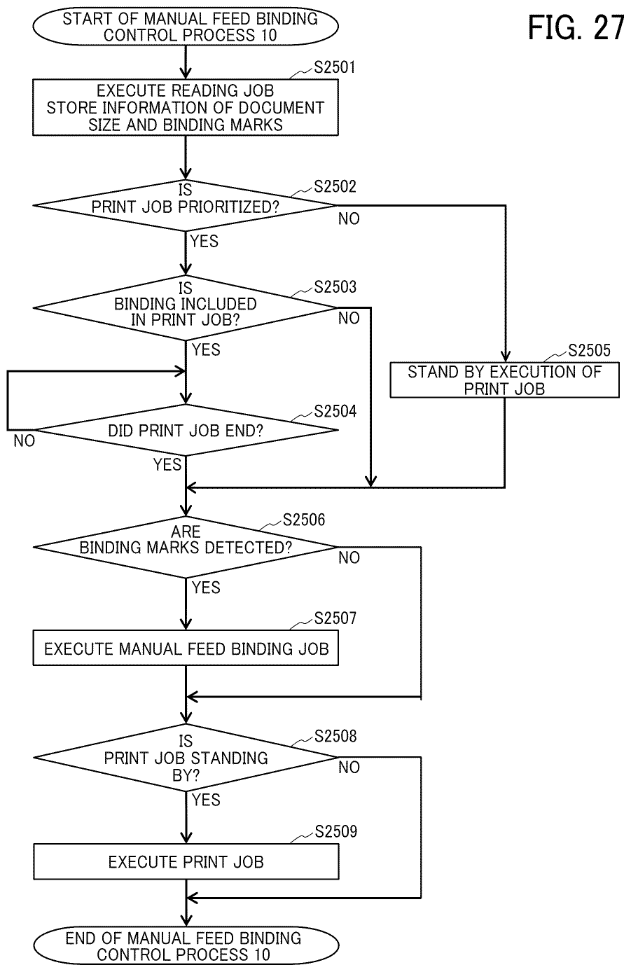

FIG. 27 is a flowchart of a manual feed binding control process 10.

FIG. 31B is a screen example of a priority setting screen.

Detailed description of points in common with the manual feed binding control process 3 will be omitted, and differences will be mainly described.

First, prior to the start of the manual feed binding control process 10, the controller 150 causes the user to set the priority order of the print job and the manual feed binding job through the priority setting screen illustrated in FIG. 31B. More particularly, in a case where a read print job is instructed, after the read job is finished, the user is caused to set whether to execute the manual feed binding job after executing the print job (in other words, the print job is prioritized) or to execute the print job after executing the manual feed binding job (in other words, the manual feed binding job is prioritized).

For example, as illustrated in FIG. 31B, the priority setting screen includes a [perform print job first] icon and a [perform manual feed binding job first] icon. Then, when the [perform print job first] icon is pressed, the controller 150 causes the memory 152 to store that the print job is prioritized. On the other hand, when the [perform manual feed binding job first] icon is pressed, the controller 150 causes the memory 152 to store that the manual feed binding job is prioritized.

Then, in a case where a read print instruction is input to the control panel 149, the controller 150 executes the manual feed binding control process 10. First, the controller 150 executes a read job, and stores the document size and the binding mark information in the memory 152 when the binding mark T is detected from the read image (step S2501). The processing of step S2501 corresponds to the processing of steps S1802, S1803, and S1204.

Then, in a case where the priority of the print job has been set through the priority setting screen (YES in step S2502), the controller 150 determines whether or not to cause the binding processing apparatus 30 to bind the sheet bundle Sb printed in the print job (in other words, whether the binding instruction is included in the read print instruction) (step S2503).

Then, when it is determined that the binding instruction is included in the read print instruction (YES in step S2503), the controller 150 executes the print job and waits for the execution of the processing in and after step S2506 until the print job is completed (NO in step S2504). When it is determined that the binding instruction is not included in the read print instruction (NO in step S2503), the controller 150 executes the print job and executes the processing in and after step S2506 in parallel with the print job. In a case where the priority of the manual feed binding job has been set through the priority setting screen (NO in step S2502), the controller 150 waits for the execution of the print job (step S2505) and executes the processing in and after step S2506.

In step S2503, the controller 150 may determine whether or not the ejection destination of the print job is the second ejection tray 32. Then, when it is determined that the ejection destination of the print job is the second ejection tray 32 (YES in step S2503), the controller 150 may execute the print job and wait for the execution of the processing in and after step S2506 until the print job is completed (NO in step S2504). When determining that the ejection destination of the print job is the first ejection tray 135 (NO in step S2503), the controller 150 may execute the print job and execute the processing in and after step S2506 in parallel with the print job.

Then, in a case where the binding mark T is detected in step S2501 (YES in step S2506), the controller 150 causes the controller 160 to execute a manual feed binding job (step S2507). The processing of step S2507 corresponds to the processing of steps S1205, S1805, S1702, and S1207. The controller 160 of the sheet binder 30 executes a manual feed binding job in accordance with an instruction from the controller 150 of the image forming system 1, and notifies the controller 150 of completion of the manual feed binding job.

Then, in a case where the controller 150 has waited for the print job in step S2505 (YES in step S2508), after notification of completion of the manual feed binding job from the controller 160, the controller 150 executes the waiting print job (step S2509). On the other hand, in a case where the controller 150 has not waited for the print job (NO in step S2508), the controller 150 skips the process of step S2509.

In other words, in steps S2505 and S2507, the controller 150 causes the controller 160 to execute the manual feed binding job in a state of waiting for execution of the print job. In other words, the controller 150 stops entry of the sheet S from the image forming device 115 to the binding processing apparatus 30 while the controller 160 is executing the manual feed binding job (in other words, until the process of the crimp binder 42 or the staple binder 43 for the document bundle Dp manually fed is completed).

### Manual Feed Binding Control Process 11

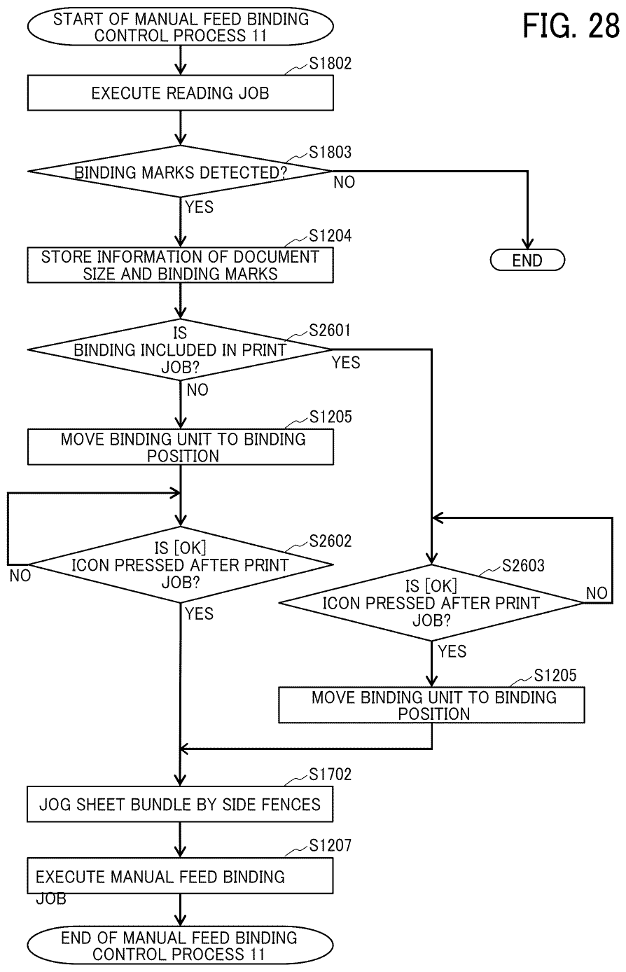

FIG. 28 is a flowchart of a manual feed binding control process 11.

Detailed description of points in common with the manual feed binding control process 3 will be omitted, and differences will be mainly described.

The manual feed binding control process 10 is mainly different from the manual feed binding control process 3 in that steps S2601 to S2603 are added. When a read print instruction is input to the control panel 149 in a state where priority of a print job is set through the priority setting screen, the controller 150 executes the manual feed binding control process 11.

When the binding mark T is detected in the read job (YES in step S1803), the controller 150 stores the document size and the binding mark information in the memory 152 (step S1204), and determines whether or not the binding processing apparatus 30 binds the sheet bundle Sb printed in the print job (in other words, whether the binding instruction is included in the read print instruction) (step S2601).

When determining that the binding instruction is not included in the read print instruction (NO in step S2601), the controller 150 instructs the controller 160 to move the binding unit to the binding position in parallel with the read job or the print job (step S1205). Then, the controller 150 causes the control panel 149 to display a manual feed binding notification screen after the read print job is completed. Then, when the [OK] icon on the manual feed binding notification screen is pressed (YES in step S2602), the controller 150 executes the processing of steps S1702 and S1207.

On the other hand, when it is determined that the binding instruction is included in the read print instruction (YES in step S2601), the controller 150 completes the read print job without executing the processing of step S1205. Then, the controller 150 causes the control panel 149 to display a manual feed binding notification screen after the read print job is completed. Then, when the [OK] icon on the manual feed binding notification screen is pressed (YES in step S2603), the controller 150 executes the processing of steps S1205, S1702, and S1207.

In other words, the controller 150 controls the timing of step S1205 based on whether or not to execute a print job after the read job (in other words, the image forming device 115 is operated) and whether or not to cause the binding processing apparatus 30 to bind the sheet bundle Sb printed in the print job (in other words, the sheet S on which the image is formed by the image forming device 115 is supplied to the binding processing apparatus 30). These are examples of the operation state of the image forming device 115.

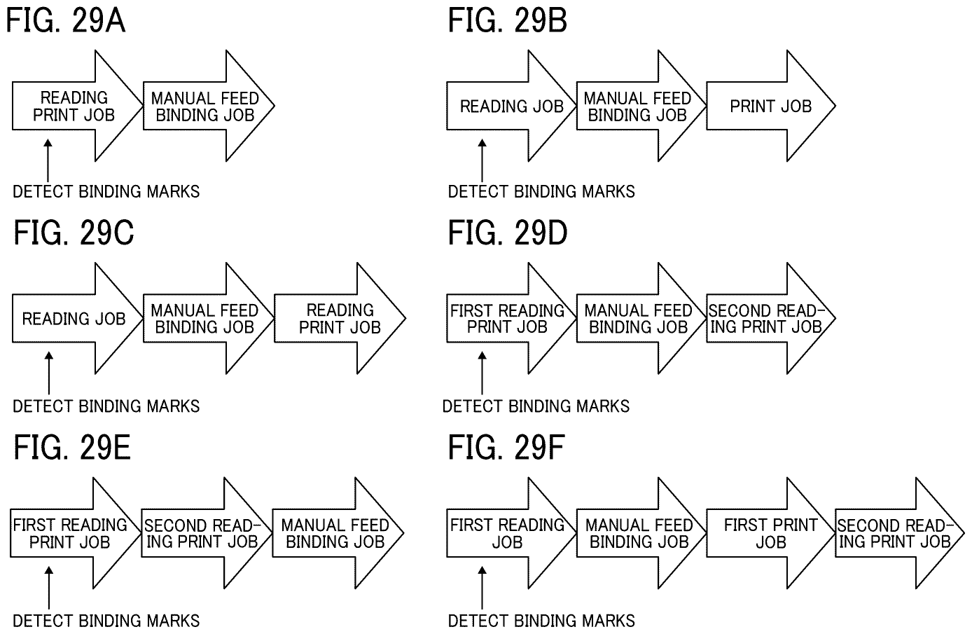

FIGS. 29A, 29B, 29C, 29D, 29E and 29F are diagrams illustrating variations in the execution order of multiple jobs.

FIGS. 29A to 29F illustrate only a part of the variations, and it goes without saying that the execution order is not limited thereto.

FIGS. 29A and 29B illustrate an execution order of each job when one read print job is instructed and the binding mark T is detected in the read job.

In this case, as illustrated in FIG. 29A, a read job, a print job, and a manual feed binding job may be executed in this order (in other words, the print job is prioritized). Alternatively, as illustrated in FIG. 29B, a read job, a manual feed binding job, and a print job may be executed in this order (in other words, the manual feed binding job is prioritized).

FIG. 29C illustrates an execution order of each job in a case where a read job (no print job) and a read print job are instructed consecutively and a binding mark T is detected in the first read job. In this case, the read job, the manual feed binding job, and the read print job may be executed in this order.

FIGS. 29D to 29F illustrate examples of the execution order of each job in a case where two read print jobs are consecutively instructed and the binding mark T is detected in the first read job. In this case, as illustrated in FIG. 29D, the first read print job, the manual feed binding job, and the second read print job may be executed in this order. As illustrated in FIG. 29E, the first read print job, the second read print job, and the manual feed binding job may be executed in this order. As illustrated in FIG. 29F, the first read job, the manual feed binding job, the first print job, and the second read print job may be executed in this order.

### Example of Functional Block Diagram of Controller

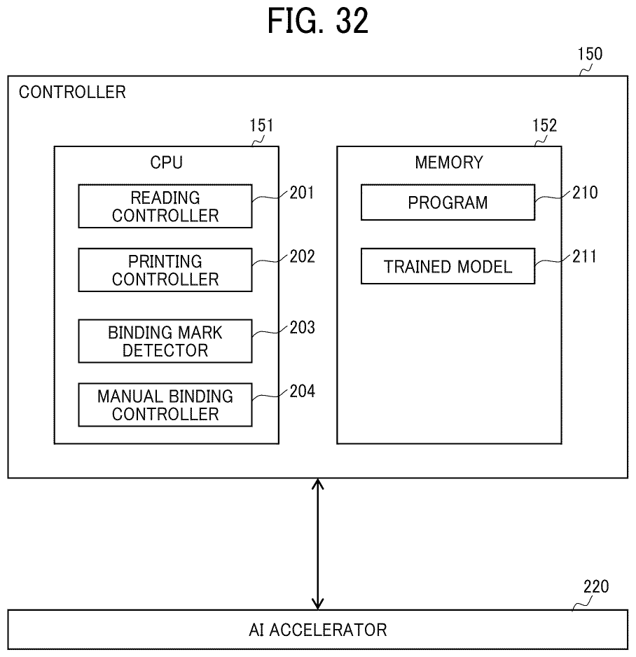

FIG. 32 is an example of a functional block diagram of the controller 150.

By executing a program 210 stored in the memory 152, the CPU 151 functions as, for example, as illustrated in FIG. 32, a reading controller 201, a printing controller 202, a binding mark detector 203, and a manual feed binding controller 204. The memory 152 stores the program 210 and a trained model 211. The controller 150 is connected to an artificial intelligence (AI) accelerator 220.

The reading controller 201 controls execution of a read job. The printing controller 202 controls execution of a print job. The binding mark detector 203 detects the binding mark T from the image data generated in the read job. The manual feed binding controller 204 instructs the controller 160 to execute a manual feed binding job. The functional blocks in the CPU 151 are conceptual, and do not necessarily need to be physically configured as illustrated in the drawings. All or a part of each functional block can be functionally or physically distributed and integrated in any unit.

The trained model 211 is generated by performing machine learning based on a training data set in a training device. In this manner, the trained model 211 is generated by applying supervised training to the base trained model.

The trained model 211 according to the present embodiment is generated by performing machine learning with a training data set based on a combination of the binding method (crimp binding and staple binding) of the crimp binder 42 and the staple binder 43 of the binding processing apparatus 30 according to the present embodiment and the shape (for example, the shape of the binding mark T of the crimp binding, the interval of the irregularities, and the width of the binding staple N) of the binding mark T of each binding unit. The training data set may include login information of the user who logs in and information indicating the state and type of the document D.

As the machine learning used for generating the trained model 211, for example, a neural network may be applied, or deep learning may be applied which is machine learning using a deep neural network (DNN). As the deep learning, for example, a convolutional neural network, a recurrent neural network (RNN), or a long-short term memory (LSTM) may be applied.

The AI accelerator 220 is hardware aiming at speeding up (acceleration) of model inference processing in a neural network. As the AI accelerator 220, a graphics processing unit (GPU) may be used, or an ASIC dedicated to, for example, the AI accelerator may be used.

The AI accelerator 220 is provided with a library for utilizing the trained model 211. Therefore, the AI accelerator 220 according to the present embodiment can incorporate the trained model 211. The AI accelerator 220 can execute image recognition using deep learning.

### Example of Processing by Controller

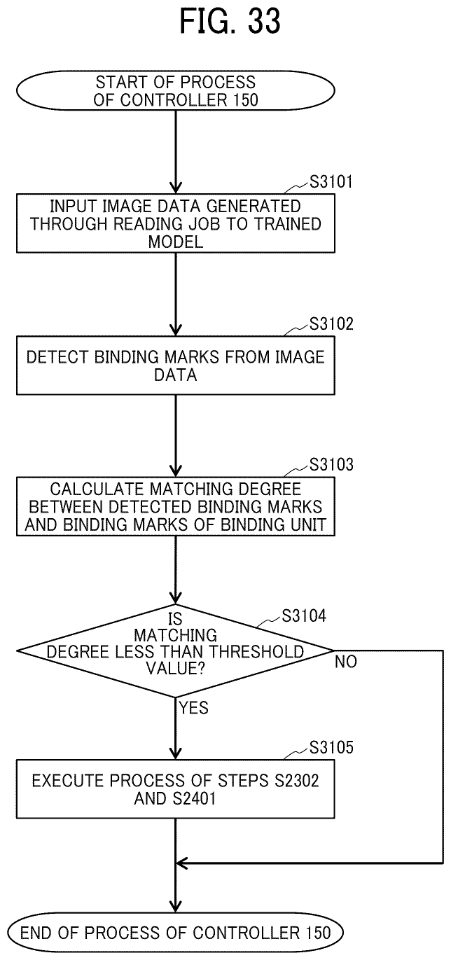

FIG. 33 is a flowchart illustrating an example of processing of the controller 150.

The processing of FIG. 33 corresponds to, for example, the processing of steps S1803, S1204, S2301, and S2302 of FIG. 25 or the processing of steps S1803, S1204, S2301, and S2401 of FIG. 26.

First, the binding mark detector 203 inputs the image data generated by the reading controller 201 in the read job to the trained model 211 (S3101). Then, the trained model 211 detects the binding mark T from the image data acquired from the binding mark detector 203 and generates binding mark information (S3102). Then, the trained model 211 compares the detected binding mark T with the (in other words, a binding mark by the crimp binder 42 or the staple binder 43) trained in advance, and calculates the degree of coincidence as a numerical value (S3103). Then, the trained model 211 outputs the binding mark information and the numerical value indicating the degree of coincidence to the manual feed binding controller 204. In other words, the controller 150 causes the trained model 211 to execute a part of the above-described processing (for example, steps S1803 and S2301).

The numerical value (an example of determination data) output from the trained model 211 increases as the degree of coincidence of the binding marks increases, and decreases as the degree of coincidence of the binding marks decreases. This processing is an example of processing of determining whether or not the binding unit may perform the processing on the document bundle Db based on the image data generated in the read job. In other words, a case where the numerical value indicating the degree of coincidence is equal to or more than a threshold corresponds to that the processing may be performed on the document bundle Db by the binding unit, and a case where the numerical value is less than the threshold corresponds to that the processing cannot be performed on the document bundle Db by the binding unit.

Then, the manual feed binding controller 204 compares the degree of coincidence acquired from the trained model 211 with a predetermined threshold (S3104). Then, when the degree of coincidence is less than the threshold (S3104: Yes), the manual feed binding controller 204 executes the processing in and after step S2302 (alternatively, step S2401 in FIG. 26) in FIG. 25 (S3105).

On the other hand, in a case where the degree of coincidence is equal to or more than the threshold (S3104: No), the manual feed binding controller 204 skips the processing of steps S2302 to S2303 (alternatively, steps S2401 to S2402 in FIG. 26) of FIG. 25 and executes the processing of step S1205 and subsequent steps. In other words, the manual feed binding controller 204 controls the binding processing apparatus 30 (more particularly, the crimp binder 42 or the staple binder 43) based on the determination result (determination data) by the trained model 211.

### Another Example of Functional Block Diagram of Controller

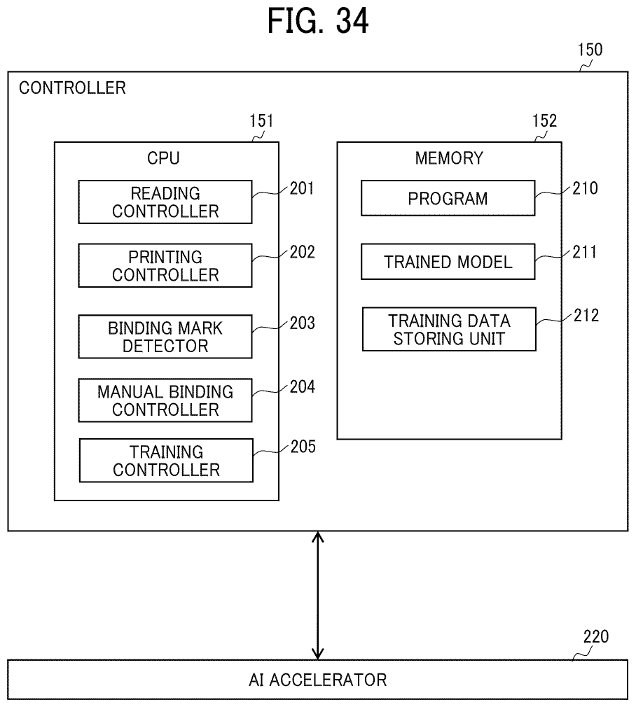

FIG. 34 is another example of a functional block diagram of the controller 150.

Detailed description of points in common with the processing of FIG. 32 will be omitted, and differences will be mainly described.

FIG. 34 is different from FIG. 32 in that the CPU 151 further functions as the training controller 205 and the memory 152 further includes a trained data storing unit 212, and is the same as FIG. 32 in other points.

The training controller 205 generates training data used for machine learning of the trained model 211 by combining a part or all of login information acquired from a user who operates the image forming system 1, image data generated by a read job, data (binding mark information, coincidence degree) output from the trained model 211, and a user's operation (pressed icon) on the control panel 149. The training controller 205 stores the generated training data in the trained data storing unit 212. The training controller 205 causes the trained model 211 to perform machine learning using the training data stored in the trained data storing unit 212 at any timing.

### Another Example of Processing of Controller

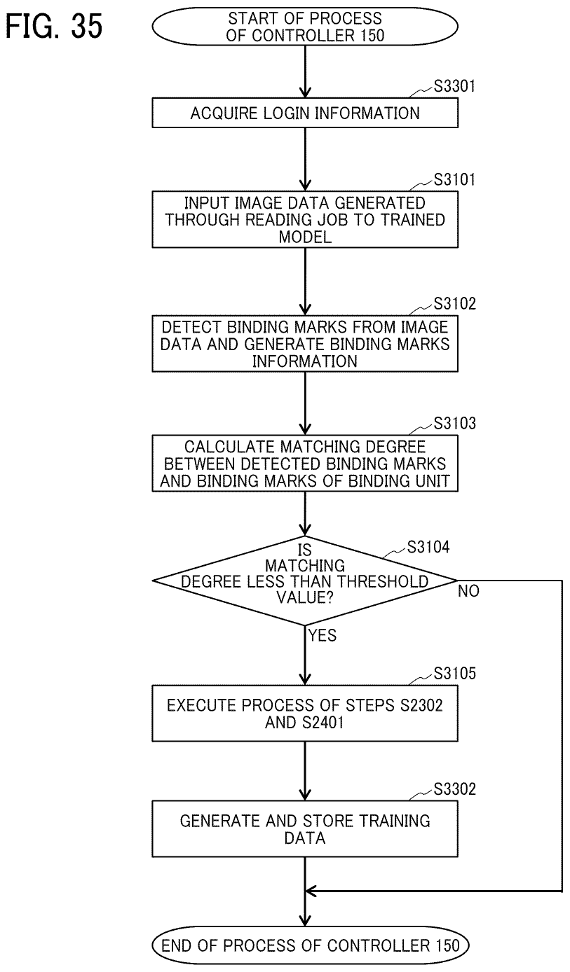

FIG. 35 is a flowchart illustrating another example of processing of the controller 150.

Detailed description of points in common with the processing of FIG. 33 will be omitted, and differences will be mainly described.

The processing of FIG. 35 is different from the processing of FIG. 33 in that steps S3301 and S3302 are added.

Prior to executing the processing of step S3101 and subsequent steps (typically, before the reading instruction is input), the controller 150 acquires login information from the user through the control panel 149 (S3301). The login information is information related to a user who operates the image forming system 1 (for example, a user identifier that uniquely identifies the user).

The training controller 205 causes the trained data storing unit 212 to store, as training data, the login information acquired in step S3301, the image data generated in step S3101, the binding mark information generated in step S3102, the matching degree calculated in step S3103, and a part or all of the identifier of the icon pressed in step S3105 in association with each other (S3302).

### Configuration Diagram of Binding Mark Detection System

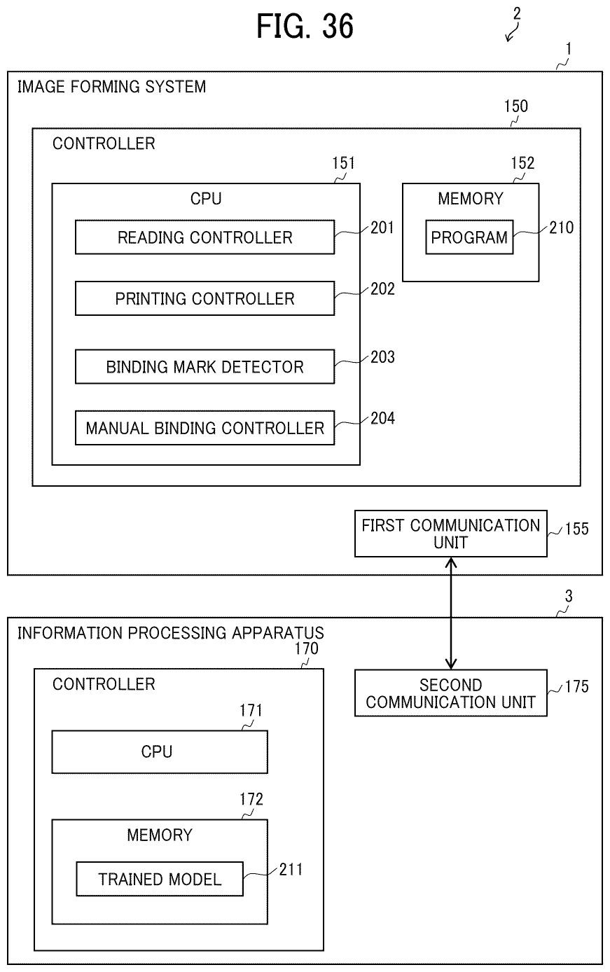

FIG. 36 is a configuration diagram of the binding mark detection system 2.

The binding mark detection system 2 is a system that detects a binding mark T from an image read in a read job. As illustrated in FIG. 36, the binding mark detection system 2 includes an image forming system 1 and an information processing apparatus 3.

The basic configuration of the image forming system 1 is common to FIGS. 1 to 11 and 32. The image forming system 1 illustrated in FIG. 36 further includes a first communication unit 155, and the trained model 211 is omitted. The controller 150 is an example of a first control unit. The information processing apparatus 3 includes a controller 170 (second control unit) including a CPU 171 and a memory 172, and a second communication unit 175. The memory 172 stores a trained model 211. The first communication unit 155 and the second communication unit 175 are interfaces that transmit and receive data through a communication network (for example, the Internet, a mobile communication line, or a local area network (LAN)).

Then, the image forming system 1 and the information processing apparatus 3 share and execute the processing illustrated in FIG. 33. In other words, the controller 150 transmits the image data generated by the read job to the information processing apparatus 3 through the first communication unit 155 (S3101). The controller 170 executes processing of steps S3102 and S3103 based on the image data received from the image forming system 1 through the second communication unit 175. Then, the controller 170 transmits determination data (binding mark information and coincidence degree) to the image forming system 1 through the second communication unit 175. The controller 150 executes the processing of steps S3104 and S3105 based on the determination data received from the information processing apparatus 3 through the first communication unit 155.

### Operation and Effect of Embodiment

According to the above embodiment, the binding mark T is detected based on the image read in the read job, and the binding unit is moved to the position facing the detected binding mark T when the document bundle Db is manually fed through the opening 31A, whereby the document bundle Db can be rebound such that the past binding mark is inconspicuous while suppressing an increase in the work load of the user.

According to the above embodiment, the productivity of the image forming system 1 can be enhanced by controlling the movement timing of the binding unit based on at least one of the operation state (for example, whether or not to execute a print job, and whether or not to cause the binding processing apparatus 30 to bind the sheet bundle Sb on which an image has been formed in the print job) of the image forming device 115 or the image (for example, whether or not the binding mark T has been detected) read in the read job. In other words, the controller 150 is configured to control timing to move the crimp binder 42 or the staple binder 43 based on whether the controller 150 detects the binding mark on the document.

According to the above embodiment, by moving the binding unit when an instruction to bind the document bundle Db is input to the control panel 149, it is possible to prevent the binding unit from being moved even in a case where the document bundle Db is not bound.

According to the above embodiment, the binding mark of the document bundle Db becomes further inconspicuous by moving one of the crimp binder 42 and the staple binder 43 (in other words, the binding mark T is bound by one of the crimp binder 42 and the staple binder 43) based on the detected shape of the binding mark T.

According to the above embodiment, in a case where the detected binding mark T is different from the binding mark by the binding unit, the fact that the binding cannot be performed similarly is notified through the binding inability notification screen. Thus, it is possible to allow the user to recognize in advance that the binding mark T becomes conspicuous.

According to the above embodiment, in a case where the total thickness of the document bundle Db is equal to or less than the maximum thickness, it is possible to prevent damage to the binding unit due to forcible binding of the document bundle Db exceeding the maximum thickness by not moving the binding unit.

According to the above embodiment, the orientation of the document bundle Db manually fed through the opening 31A is notified through the manual feed notification screen, so that the document bundle Db can be bound again at the position of the binding mark T.

According to the above embodiment, by separating the trained model 211 from the image forming system 1, resources (for example, the load of the CPU 151 and the capacity of the memory 152) of the image forming system 1 can be reduced. By connecting the multiple image forming systems 1 to the information processing apparatus 3, the processing of the trained model 211 can be shared by the multiple image forming systems 1.

The present disclosure is not limited to the embodiments described above, and various variations are possible within the scope of the technical gist thereof, and all the technical matters included in the technical idea recited in claims are the object of the present disclosure. The above-described embodiments represent examples, and various modifications can be achieved by those skilled in the art from the disclosed contents. Such modifications are included in the technical scope recited in the claims.

Each processing described above may be implemented by, for example, a program or the like. In other words, the CPU 151 or 161 may execute the programs stored in the memories 152 and 162 to implement the above-described processes. The program is not limited to a single program, and may be an aggregate of multiple programs. The program is not limited to being executed by one of the CPUs 151 and 161, and may be shared and executed by the CPUs 151 and 161. The program may be written in, for example, a storage device or a storage medium and distributed with the storage device or the storage medium, or may be distributed through, for example, an electric communication line.

A description is given below of some aspects of an embodiment of the present disclosure.

### Aspect 1

In Aspect 1, a processing system includes a post-processing apparatus, a control unit, and a document reader. The post-processing apparatus includes a processing device that performs processing on a medium on which an image is formed and an ejector that ejects the medium processed by the processing device from an opening. The control unit controls the post-processing unit. The document reader reads an image on one or more documents. The control unit detects a binding mark of the one or more documents from the image read by the document reader, and moves the processing unit to a position facing the detected binding mark when the multiple documents is manually fed through the opening.

### Aspect 2

In Aspect 2, in the processing system according to Aspect 1, the control unit controls timing to move the processing device based on an image read by the document reader.

### Aspect 3

In Aspect 3, the processing system according to Aspect 1 or Aspect 2 further includes an input device that receives an input from a user. The control unit causes the user to input whether or not to bind the multiple documents through the input device when the binding mark is detected from the image read by the document reader, and moves the processing device when an instruction to bind the multiple documents is input to the input device.

### Aspect 4

In Aspect 4, in the processing system according to any one of Aspects 1 to 3, the processing device includes a first processing unit and a second processing unit. The first processing unit presses and deforms the multiple documents and binds the documents. The second processing unit causes a staple to penetrate the multiple documents and binds the documents. The control unit moves one of the first processing unit and the second processing unit based on a shape of the detected binding mark.

### Aspect 5

In Aspect 5, the processing system according to any one of Aspects 1 to 4 further includes an output device and an input device. The output device outputs a notification of information to a user. The input device receives an input from the user. When the detected binding mark is different from a binding mark in a case of binding by the processing unit, the control unit notifies through the output device that binding is not performed similarly to the detected binding mark. When an instruction to bind the multiple documents is input to the input device, the control unit moves the processing device.

### Aspect 6

In Aspect 6, in the processing system according to any one of Aspect 1 to Aspect 5, the control unit moves the processing device when a total thickness of the multiple documents read by the document reader is equal to or less than a maximum thickness allowed to be bound by the processing device.

### Aspect 7

In Aspect 7, the processing system according to any one of Aspects 1 to 6 further includes an output device that outputs a notification of information to a user. The control unit notifies, through the output device, of an orientation of the multiple documents to be manually fed through the opening.

### Aspect 8

In Aspect 8, in the processing system according to any one of Aspects 1 to 7, the control unit stops entry of the medium into the post-processing device until processing of the processing device on the document that is manually fed is completed.

### Aspect 9

In Aspect 9, a non-transitory recording medium stores multiple instructions which, when executed by one or more processors of a processing system including a document reader that reads an image on one or more documents, and a post-processing apparatus including a processing device that performs processing on a medium on which the image is formed and an ejector that ejects the medium processed by the processing device from an opening, causes the one or more processors to perform a method comprising detecting a binding mark of the one or more documents from the image read by the document reader, and moving the processing device to a position facing the detected binding mark when the multiple documents is manually fed through the opening.

### Aspect 10

In Aspect 10, in the non-transitory recording medium storing multiple instructions according to Aspect 9, the method includes stopping entry of the medium into the post-processing device until processing of the processing device on the document that is manually fed is completed.

### Aspect 11

In Aspect 11, a binding mark detection system includes a processing system and an information processing apparatus. The processing system includes a document reader that reads an image on one or more documents, a post-processing apparatus that performs processing on the multiple documents, a first communication unit that transmits and receives data to and from the information processing apparatus, and a first control unit that controls the processing system. The information processing apparatus includes a second communication unit that transmits and receives data to and from the processing system, and a second control unit that controls the information processing apparatus. The first control unit transmits image data generated by reading the one or more documents by the document reader to the information processing apparatus through the first communication unit. The second control unit determines whether or not to allow the post-processing apparatus to perform processing on the one or more documents based on the image data received from the processing system through the second communication unit. Determination data indicates a determination result being transmitted to the processing system through the second communication unit. The first control unit controls the post-processing apparatus based on the determination data received from the information processing apparatus through the first communication unit.

### Aspect 12

In Aspect 12, a processing system includes a post-processing apparatus, a document reader, and circuitry. The post-processing apparatus includes a housing, a processing device, and an ejector. The housing has an opening. The processing device performs a post-processing on a medium on which an image is formed. The ejector ejects the medium subjected to the post-processing by the processing device, from the opening. The document reader reads an image on a document of multiple documents. The circuitry is to detect a binding mark on the document from the image read by the document reader, and move the processing device to a binding position facing the binding mark on the document, when the multiple documents is manually fed through the opening of the post-processing apparatus.

### Aspect 13

In Aspect 13, in the processing system according to Aspect 11, the circuitry is further to control timing to move the processing device based on the image read by the document reader.

### Aspect 14

In Aspect 14, in the processing system according to Aspect 13, the circuitry is further to control timing to move the processing device based on whether the circuitry detects the binding mark on the document.

### Aspect 15

In Aspect 15, the processing system according to Aspect 11 or Aspect 14 further includes an input device to receive an input. The circuitry is further to receive, by the input device, an instruction on whether the multiple documents are to be bound, when the circuitry detects the binding mark on the document, and cause the processing device to move to the binding position when the input device receives the instruction to bind the multiple documents.

### Aspect 16

In Aspect 16, in the processing system according to any one of Aspects 11 to 15, the processing device includes a first processing unit and a second processing unit. The first processing unit presses and deforms the multiple documents to bind the multiple documents. The second processing unit causes a staple to penetrate the multiple documents to bind the multiple documents. The circuitry is further to cause one of the first processing unit and the second processing unit to move to the binding position based on a shape of the binding mark on the document.

### Aspect 17

In Aspect 17, the processing system according to any one of Aspects 11 to 16 further includes an input-output device including an output device and an input device. The output device outputs a notification of information. The input device receives an instruction to perform a binding operation as the post-processing. The circuitry is further to: determine whether a first binding mark detected by the circuitry is different from a second binding mark to be bound by the processing device; output, via the output device, a notification that the second binding mark to be marked on the multiple documents by the processing device is different from the first binding mark detected by the circuitry, when it is determined that the first binding mark is different from the second binding mark; and move the processing device to the binding position to perform the binding operation, when the input device receives the instruction to perform the binding operation on the multiple documents.

### Aspect 18

In Aspect 18, in the processing system according to any one of Aspects 11 to 17, the circuitry is further to move the processing device when a total thickness of the multiple documents read by the document reader is equal to or less than a maximum thickness allowed to be bound by the processing device.

### Aspect 19

In Aspect 19, the processing system according to any one of Aspects 11 to 18 further includes an output device to output a notification of information to a user. The circuitry is further to output, via the output device, a notification of an orientation of the multiple documents to be manually fed through the opening.

### Aspect 20

In Aspect 20, in the processing system according to any one of Aspects 11 to 19, the circuitry is further to stop an entry of the medium into the post-processing apparatus until processing of the processing device on the document that is manually fed is completed.

### Aspect 21

In Aspect 21, a non-transitory recording medium stores a program which, when executed by one or more processors of a processing system including a document reader to read an image on a document of multiple documents, and a post-processing apparatus including a housing having an opening, a processing device to perform a post-processing on a medium on which an image is formed, and an ejector to eject the medium subjected to the post-processing by the processing device, from the opening. The processing system causes the one or more processors to perform a method including detecting a binding mark on the document from the image read by the document reader, and moving the processing device to a binding position facing the binding mark when the multiple documents including the document is manually fed through the opening of the post-processing apparatus.

### Aspect 22

In Aspect 22, in the non-transitory recording medium storing the program according to Aspect 21, the method further includes stopping an entry of the medium into the post-processing apparatus until processing of the processing device on the document that is manually fed is completed.

### Aspect 23

In Aspect 23, a binding mark detection system includes a processing system and an information processing apparatus. The processing system includes a document reader, a post-processing apparatus, a first communicator, and first circuitry. The document reader reads an image on a document. The post-processing apparatus performs a post-processing on multiple documents including the document. The first circuitry is to control the processing system. The information processing apparatus transmits and receives data with respect to the first communicator of the processing system. The information processing apparatus includes a second communicator and second circuitry. The second communicator transmits and receives data with respect to the processing system. The second circuitry is to control the information processing apparatus. The first circuitry is further to send image data generated by reading the document by the document reader to the information processing apparatus via the first communicator. The second circuitry is further to determine whether to allow the post-processing apparatus to perform a post-processing on the document based on the image data received from the processing system through the second communicator, and transmit determination data that indicates a determination result to the processing system through the second communicator. The first circuitry is further configured to control the post-processing apparatus based on the determination data received from the information processing apparatus through the first communicator.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A processing system comprising:
a post-processing apparatus including:
a housing having an opening;
a processing device to perform a post-processing on a medium on which an image is formed; and
an ejector to eject the medium subjected to the post-processing by the processing device, from the opening;
a document reader to read an image on a document of multiple documents; and
circuitry configured to:
detect a binding mark on the document from the image read by the document reader; and
move the processing device to a binding position facing the binding mark on the document,
when the multiple documents is manually fed through the opening of the post-processing apparatus.

2. The processing system according to claim 1,
wherein the circuitry is further configured to control timing to move the processing device based on the image read by the document reader.

3. The processing system according to claim 2,
wherein the circuitry is further configured to control timing to move the processing device based on whether the circuitry detects the binding mark on the document.

4. The processing system according to claim 1, further comprising an input device to receive an input,
wherein the circuitry is further configured to:
receive, by the input device, an instruction on whether the multiple documents are to be bound,
when the circuitry detects the binding mark on the document, and
cause the processing device to move to the binding position when the input device receives the instruction to bind the multiple documents.

5. The processing system according to claim 1,
wherein the processing device includes:
a first processing unit to press and deform the multiple documents to bind the multiple documents; and
a second processing unit to cause a staple to penetrate the multiple documents to bind the multiple documents, and
the circuitry is further configured to cause one of the first processing unit and the second processing unit to move to the binding position based on a shape of the binding mark on the document.

6. The processing system according to claim 1, further comprising an input-output device including:
an output device to output a notification of information; and
an input device to receive an instruction to perform a binding operation as the post-processing,
wherein the circuitry is further configured to:
determine whether a first binding mark detected by the circuitry is different from a second binding mark to be bound by the processing device;
output, via the output device, a notification that the second binding mark to be marked on the multiple documents by the processing device is different from the first binding mark detected by the circuitry,
when it is determined that the first binding mark is different from the second binding mark; and
move the processing device to the binding position to perform the binding operation,
when the input device receives the instruction to perform the binding operation on the multiple documents.

7. The processing system according to claim 1,
wherein the circuitry is further configured to move the processing device when a total thickness of the multiple documents read by the document reader is equal to or less than a maximum thickness allowed to be bound by the processing device.

8. The processing system according to claim 1, further comprising an output device to output a notification of information to a user,
wherein the circuitry is further configured to output, via the output device, a notification of an orientation of the multiple documents to be manually fed through the opening.

9. The processing system according to claim 1,
wherein the circuitry is further configured to stop an entry of the medium into the post-processing apparatus until processing of the processing device on the document that is manually fed is completed.

10. A non-transitory recording medium storing a program which, when executed by one or more processors of a processing system including:
a document reader to read an image on a document of multiple documents; and
a post-processing apparatus including:
a housing having an opening;
a processing device to perform a post-processing on a medium on which an image is formed; and
an ejector to eject the medium subjected to the post-processing by the processing device, from the opening,
the processing system causing the one or more processors to perform a method comprising:
detecting a binding mark on the document from the image read by the document reader, and
moving the processing device to a binding position facing the binding mark when the multiple documents including the document is manually fed through the opening of the post-processing apparatus.

11. The non-transitory recording medium storing the program according to claim 10,
wherein the method further comprising stopping an entry of the medium into the post-processing apparatus until processing of the processing device on the document that is manually fed is completed.

12. A binding mark detection system comprising:
a processing system including:
a document reader to read an image on a document;
a post-processing apparatus to perform a post-processing on multiple documents including the document;
a first communicator; and
first circuitry configured to control the processing system; and
an information processing apparatus to transmit and receive data with respect to the first communicator of the processing system, the information processing apparatus including:
a second communicator to transmit and receive data with respect to the processing system; and
second circuitry configured to control the information processing apparatus,
wherein the first circuitry is further configured to send image data generated by reading the document by the document reader to the information processing apparatus via the first communicator,
the second circuitry is further configured to:
determine whether to allow the post-processing apparatus to perform a post-processing on the document based on the image data received from the processing system through the second communicator; and
transmit determination data that indicates a determination result to the processing system through the second communicator, and
the first circuitry is further configured to control the post-processing apparatus based on the determination data received from the information processing apparatus through the first communicator.
